(19) United States
(12) Patent Application Publication
(10) Pub. No.: US 2007/0166689 A1
(43) Pub. Date: Jul. 19, 2007

(54) CHECKLIST BUILDER AND REPORTING FOR SKILLS ASSESSMENT TOOL

(75) Inventors: Lucas K. Huang, Columbia, MD (US); Chaflc A. Kazoun, Chevy Chase, MD (US)

Correspondence Address: STRATEGIC PATENT GROUP, P.C., P.O. BOX 1329, MOUNTAIN VIEW, CA, 94042, US

(73) Assignee: Atellis, Inc., Silver Spring, MD (US)

(21) Appl. No.: 11/610,429

(22) Filed: Dec. 13, 2006

Related U.S. Application Data
(60) Provisional application No. 60/749,578, filed on Dec. 13, 2005.

(51) Int. Cl. G09B 25/00

(52) U.S. Cl. 434/365

(57) ABSTRACT

An improved skills assessment tool hosted by a server downloads a checklist builder to a client as software component. When the software component is executed, a checklist builder interface is displayed through a browser at the client. A user creates checklist data through the checklist builder interface, which provides a WYSIWYG environment. Checklist data is stored locally and sent to the server in a single request. When a completed checklist is submitted to the skills assessment tool, the selected answers are stored without scoring. The scoring occurs during report generation by the reporting tool of the skills assessment tool. The reporting tool is integrated with the checklist builder, so that a user may be returned to the checklist builder interface at the client to modify question parameters for any question in the checklist. The selected answers are rescored and the category filters reapplied, and the report is generated.

### CROSS-REFERENCE TO RELATED APPLICATION

This application claims priority to the co-pending U.S. provisional patent application No. 60/749,578 entitled “Method and System for Assessing Skills”, filed on Dec. 13, 2005.

### BACKGROUND OF THE INVENTION

Standardized medical exams have been used to assess students' clinical skills, also known as “bed side manner.” In the past, exams have been used in the U.S. to test clinical skills of international students for their ability to interact with, examination, and evaluate patients. Nowadays, more and more US medical schools are incorporating assessment of clinical skills in curriculums. Such clinical skill assessments generally involve performing simulated patient examinations on patients. The patients are trained actors playing the role of patients who exhibit symptoms of various ailments to be examined by students during simulated examination sessions. During each simulated examination session, which usually takes place in an assigned examination room, the student interacts with the patient during an appointed time period, e.g., a 15 minute session to make a diagnosis of the patient's ailment and to prescribe a proposed treatment plan. Each examination room is equipped with monitoring equipment, including audio, visual and time recoding devices, so that the student's simulated encounter with the patient can be monitored in real time by an evaluator, such as a teaching assistant or upper class person. The encounter may also be recorded for evaluation at a later time by others.

Typically, the monitoring equipments are controlled by an administrator in a central control center or by a technician in each examination room, who configures them according to the requirement of the examination room for a particular case type. After each examination session, the student and patient are required to complete corresponding “post simulated encounter” assessments specific to the case type under examination. The post assessment of the simulated encounter can include a multiple choice checklist, subjective/objective assessment plan (“SOAP”), notes, essay questions or any combination thereof.

As stated above, the examination sessions can be recorded via audio and visual equipments for review by other evaluators, such as faculty members, professors, etc., either in real-time or at a future date. The evaluators score the students' performance based on a checklist of objective parameters. Such assessment can also be based on subjective parameters or model answers. Faculty members can also review the student's performance as a clinical practitioner by reviewing the evaluation records. Results can be aggregated for scoring in different ways, for example, based on absolute or relative criteria, such as compared to peer group data.

Because of the time consuming and labor intensive nature of assessing the skills of multiple students with multiple patients, in multiple cases, web-based tools exist for use in clinical skill assessments. Using these tools, checklists or questionnaires are created using a browser at a client, with the client communicating with a web server through multiple client-server requests. FIG. 1 is a flowchart illustrating an example prior art checklist creation process. Typically, each time a user modifies a question, the server pops up a new window to facilitate the modification (see steps 10-16). The user enters the modification, which the client then sends to the server through a request. To preview the modified checklist, a page reload or refresh by the server is required. This process is repeated until the checklist creation is complete. However, checklist building in this manner requires multiple client-server requests, which limits the efficiency of the network. The user experience is also limited due to the multiple popup windows.

When a checklist is completed or filled out during or after an assessment, the answers to the questions in the checklist are sent to the server. The server scores each question and stores the data. Different types of content (text, video, audio, etc.) associated with an assessment are typically stored in separate systems. During the checklist completion process, if a user wishes to view the content associated with an assessment, these systems need to be accessed separately, making the process cumbersome for the user. A similar problem exists when a user, such as a student, accesses the assessment tool to view the completed checklists. Further, data analysis to identify bad questions is required prior to the scoring of the questions, so that these questions do not affect the overall scoring. Such data analysis typically requires the export of the data to third party applications and may require a significant time to complete.

Reports may be generated for the stored data. If a user wishes to view a report with different parameters for the questions in the checklist, then the user must exit the reporting tool, modify the checklist, and perform the scoring and data analysis again. This approach limits the ability of a user to generate reports.

Accordingly, there exists a need for an improved skills assessment tool that increases the ease and efficiency in checklist building, reporting, and client-server communications. The present invention addresses such a need.

### SUMMARY OF THE INVENTION

An improved skills assessment tool hosted by a server downloads a checklist builder to a client as a software component. When the software component is executed, a checklist builder interface is displayed through a browser at the client. A user creates checklist data through the checklist builder interface, which provides a WYSIWYG environment. Checklist data is stored locally and sent to the server in a single request. When a completed checklist is submitted to the skills assessment tool, the selected answers are stored without scoring. The scoring occurs during report generation by the reporting tool of the skills assessment tool. The reporting tool is integrated with the checklist builder, so that a user may be returned to the checklist builder interface at the client to modify question parameters for any question in the checklist. The selected answers are rescored and the category filters reapplied, and the report is generated.

### BRIEF DESCRIPTION OF THE FIGURES

FIG. 1 is a flowchart illustrating an example prior art checklist creation process.

FIG. 2A is a diagram illustrating a skills assessment system according to an exemplary embodiment of the invention.

FIG. 2B is a diagram illustrating the skills assessment tool according to an exemplary embodiment of the invention.

FIG. 3 is a diagram illustrating the communication between the client and the server by the checklist builder.

FIG. 4 is a flowchart illustrating a contextual workflow of the checklist builder interface.

FIGS. 5-1 through 5-32 illustrate example checklist builder interface screens displayed through the browser at the client.

FIG. 6 is a flowchart illustrating the checklist submission in an exemplary embodiment of the invention.

FIG. 7 is a flowchart illustrating the report generating process in an exemplary embodiment of the invention.

### DETAILED DESCRIPTION

The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

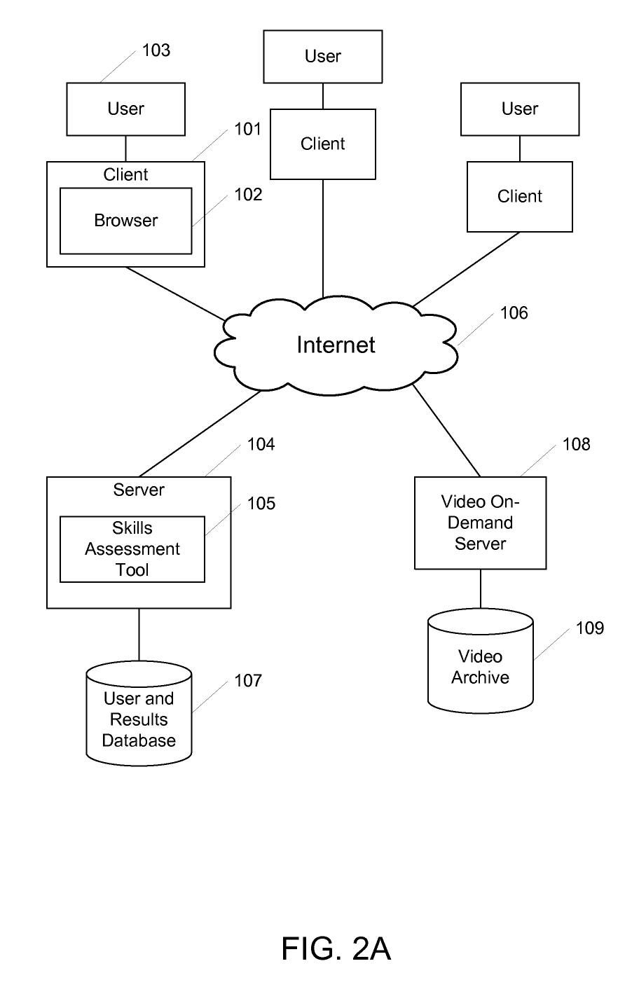

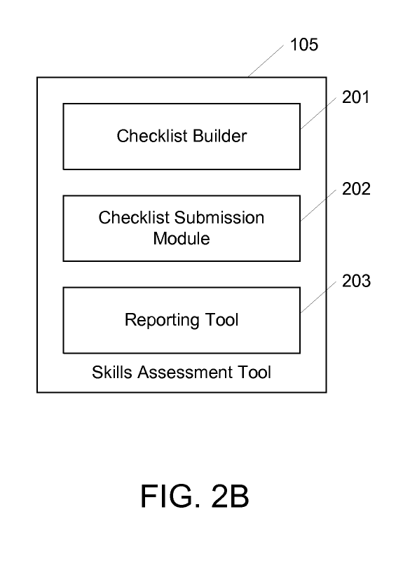

FIG. 2A is a diagram illustrating a skills assessment system according to an exemplary embodiment of the invention. The system includes one or more clients 101 communicating with a server 104 over a network, such as the Internet 106. The server 104 may comprise one or more web servers, or any type, number or configuration of servers. The server 104 hosts a skills assessment tool 105 for facilitating clinical skills testing. Users 103, such as administrators, students, and evaluators, interact with the skills assessment tool 105 through a browser 102 residing locally at the client 101. The skills assessment tool 105 stores its data in a user and results database 107. Optionally, videos associated with one or more assessments are hosted by a video on-demand server 108 with the videos stored in a video archive 109.

FIG. 2B is a diagram illustrating the skills assessment tool according to an exemplary embodiment of the invention. The skills assessment tool 105 includes a checklist builder 201, a checklist submission module 202, and a reporting tool 203.

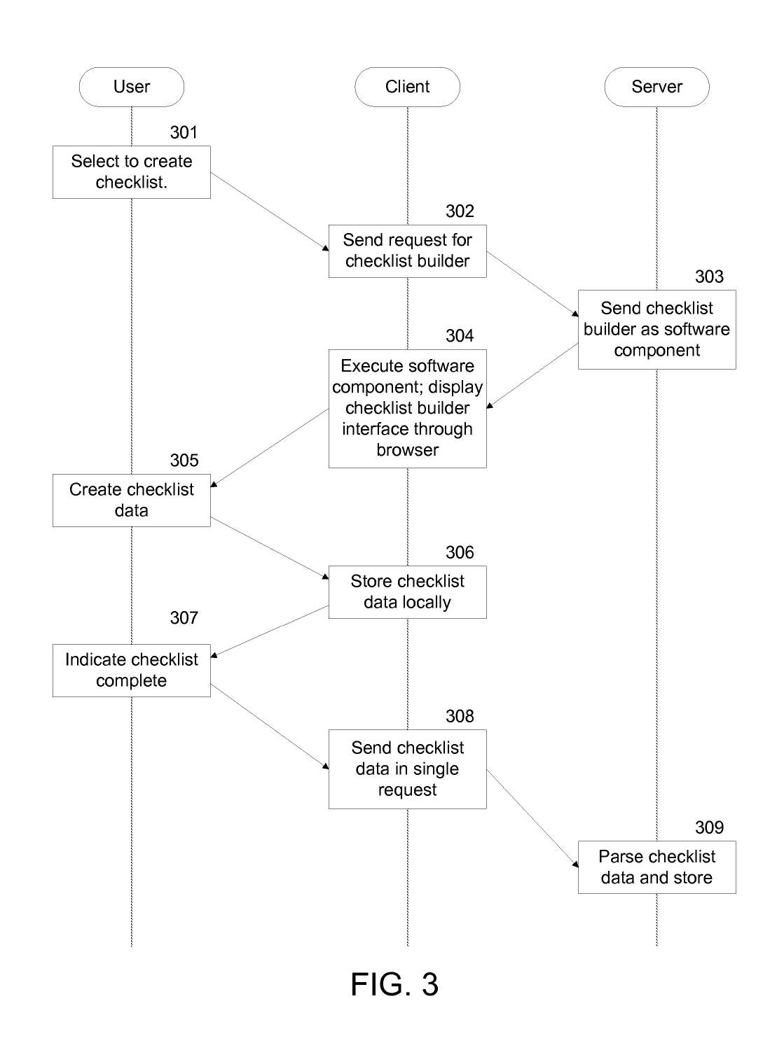

The checklist builder 201 is downloaded onto the client 101 as software component. When the software component is executed, a checklist builder interface is displayed through a browser at the client 101. A user 103 can create checklists at a client 101 through the checklist builder interface. The checklist builder 201 is described further below with reference to FIGS. 3 through 5. A “checklist”, as used in this specification, is a set of questions (dichotomous items, multiple choice, essays, etc.) that is completed by a user to assess the performance of a student in a case. A “case” is a scenario or encounter with a patient or simulator that a student needs to assess. Multiple cases can be organized into a “project”. For each case, one or more checklists may be completed. Each checklist contains any number of questions. A checklist can be completed at different times during the assessment. Different types of checklists can be created for the different roles of the user 103.

For example, in a clinical skills assessment, the user 103 can be the patient, student, faculty, and or monitor, with each role having a corresponding checklist. A patient checklist can be used to provide quantitative and/or qualitative information about their encounter(s) with the student. Patient checklists can be completed by the patient immediately after the student encounter to record whether or not specific questions were asked by the student, or whether specific physical exam maneuvers were performed. Subjective questions such as how the patient felt about the student's “bedside manner” may also be on a checklist.

Student checklists are used to obtain information from the students, usually containing questions about the patient they just saw. Student checklists can be formatted so that the student can see images, hear sounds, and be asked to interpret them. The student checklist can be designated to be scored by a faculty.

Faculty checklists are used to grade student checklists in cases when the system cannot automatically score the checklist, i.e., when the student checklist contains free-text questions.

Monitor checklists can be used for two main purposes. First, the monitor checklist assists in the assessment of the student. The monitor would fill out a checklist that is supplemental to the checklist filled out by the patient. Second, the monitor provides quality assurance of the patients. The monitor fills out the same checklist as the patient, and the two will later be compared to make sure the patient is recalling things correctly.

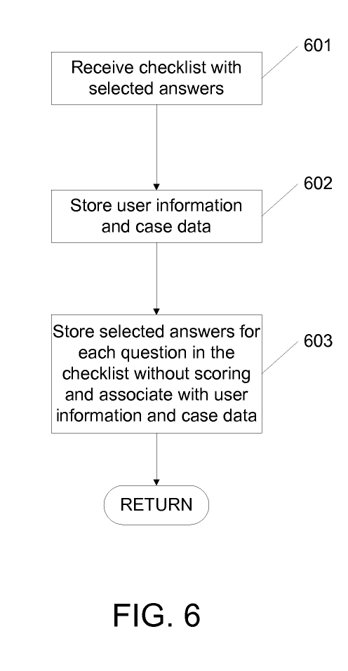

The checklist submission module 202 receives, processes, and stores completed checklists, user information, and case data. The checklist submission module 202 is described further below with reference to FIG. 6.

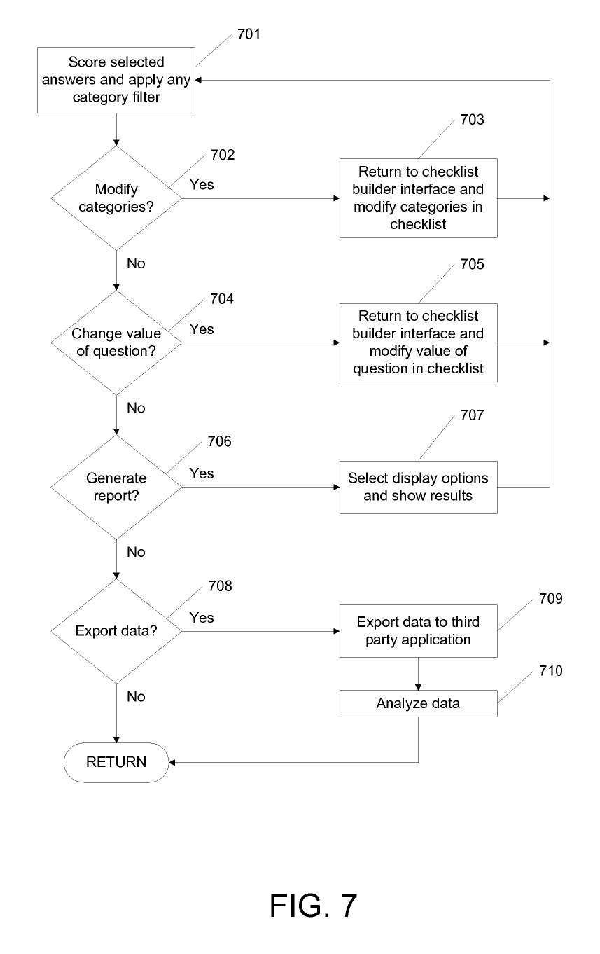

The reporting tool 203 analyzes the stored data and generates reports on the data, and is integrated with the checklist builder 201. The reporting tool 203 is described further below with reference to FIG. 7.

Checklist Builder

The checklist builder 201 allows for the efficient creation of checklists. The checklist builder 201 is downloaded to the client 101 as a software component. When the software component is executed, a checklist builder interface is displayed through a browser 102 at the client 101. The checklist builder 201 facilitates a thin client in the checklist creation process, where data requests between the client 101 and the server 104 is minimized.

FIG. 3 is a diagram illustrating the communication between the client and the server by the checklist builder. First, a user 103 at a client 101 selects to create a checklist (step 301). In response, the client 101 sends a request for the checklist builder 201 to the server 104 (step 302). The server 104 sends to the client 101 the checklist builder 201 as a software component (step 303). In the exemplary embodiment, the software component comprises Flash action scripts that are downloaded and executed within the context of a Flash program. Any number of other technologies can be used to implement the checklist builder software component, such as Java scripts, applets, executables, etc. When the client 101 executes the checklist builder software component, a checklist builder interface is displayed through the browser 102 residing locally at the client 101 (step 304).

Using the checklist builder interface, the user 103 creates checklist data (step 305). As the checklist is created, the client 101 stores the checklist data locally (step 306). When the user 103 indicates that the modifications to the checklist is complete (step 307), the client 101 sends the checklist data to the server 104 in a single request (step 308). The server 104 then parses the checklist data and stores it in the user and results database 107 (step 309). By sending a single request with the checklist data once the checklist is complete, rather than numerous data requests throughout the checklist creation process, communications between the client 101 and the server 104 are significantly reduced over the prior art.

In the exemplary embodiment, the checklist builder interface provides a “WYSIWYG” (what-you-see-is-what-you-get) environment for the user 103 at the client 101. As the user creates the checklist, the checklist builder interface displays the checklist as it would be seen by a user when filling out the checklist. No page reloads from the server 104 is required. Popup windows for the entering of question parameters are minimized. In addition, the checklist builder interface incorporates the “drag and drop” functionality, increasing the intuitiveness of the builder's use.

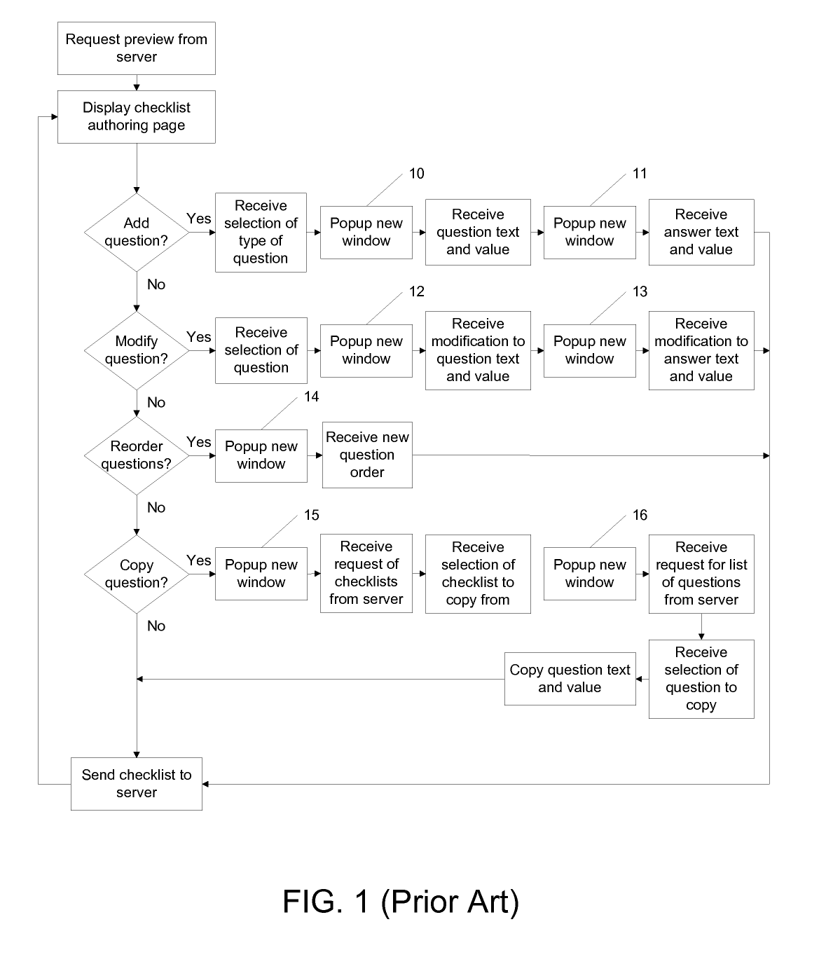

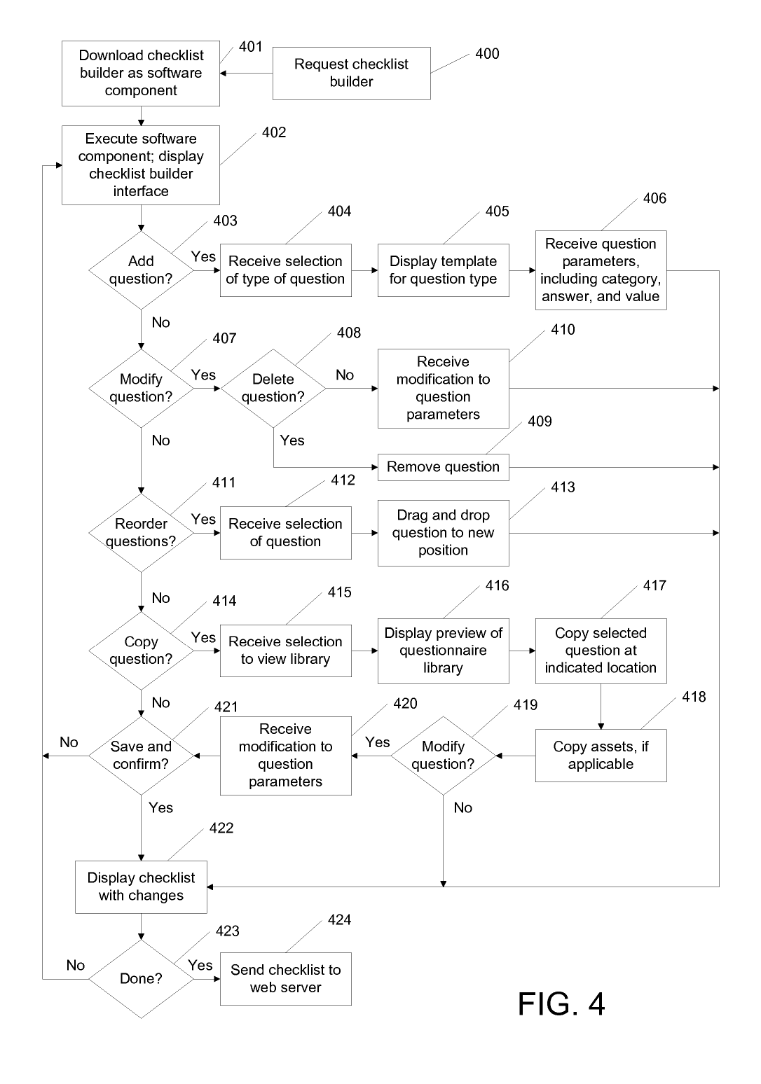

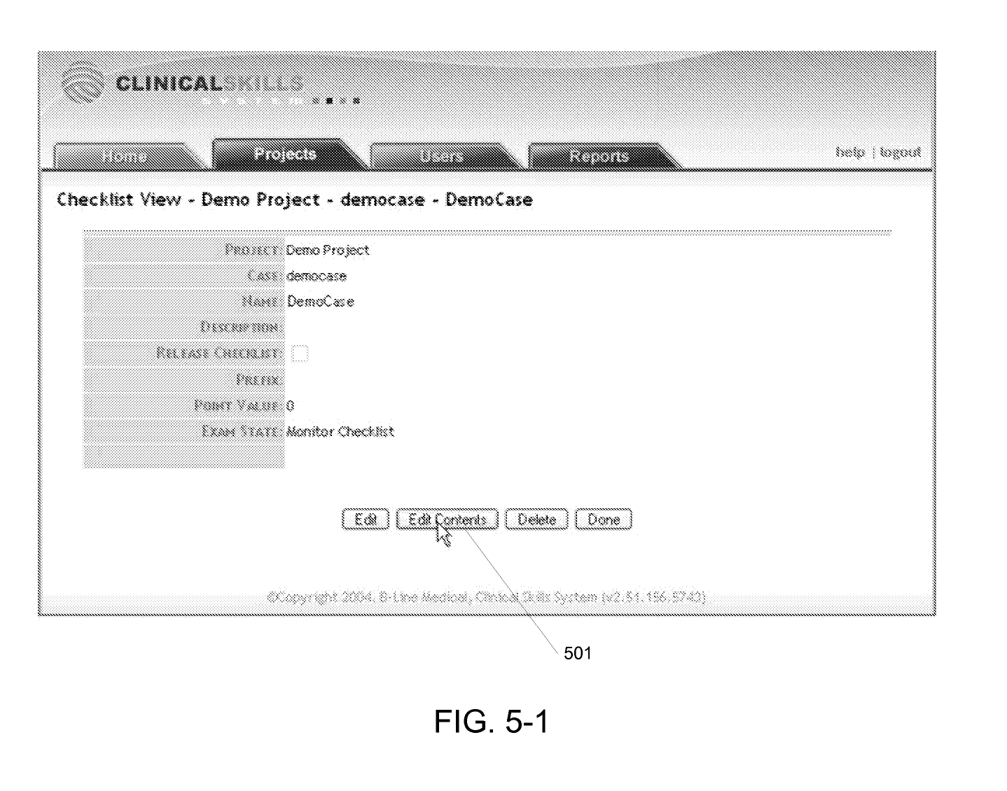

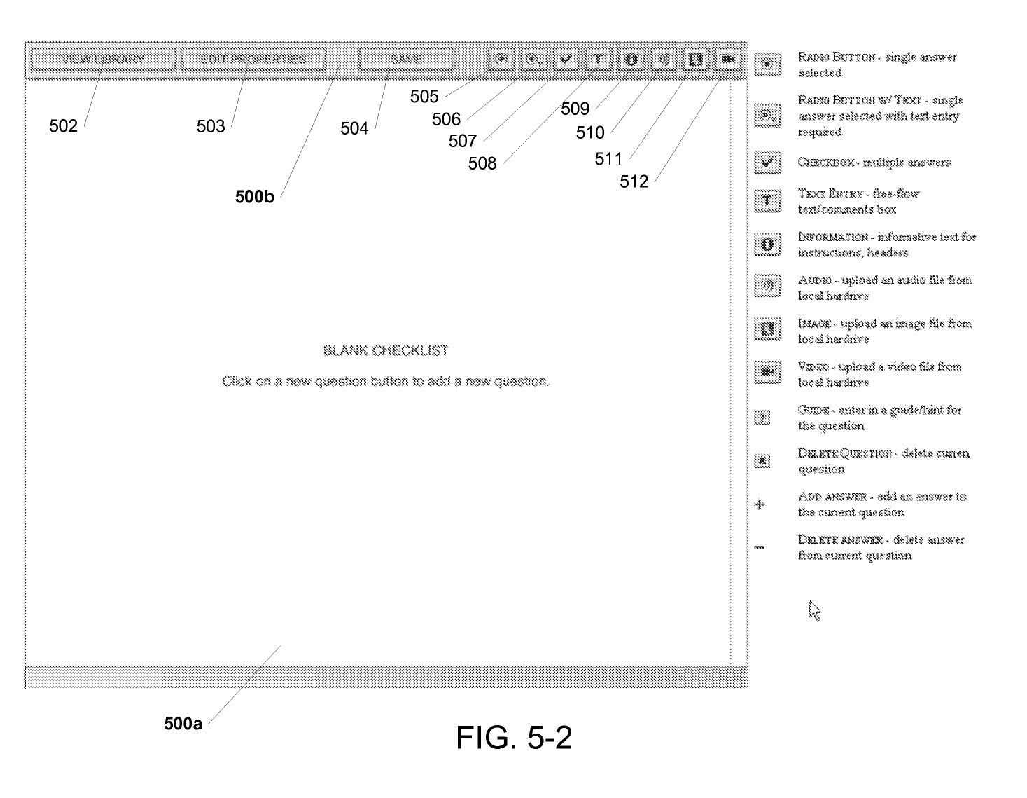

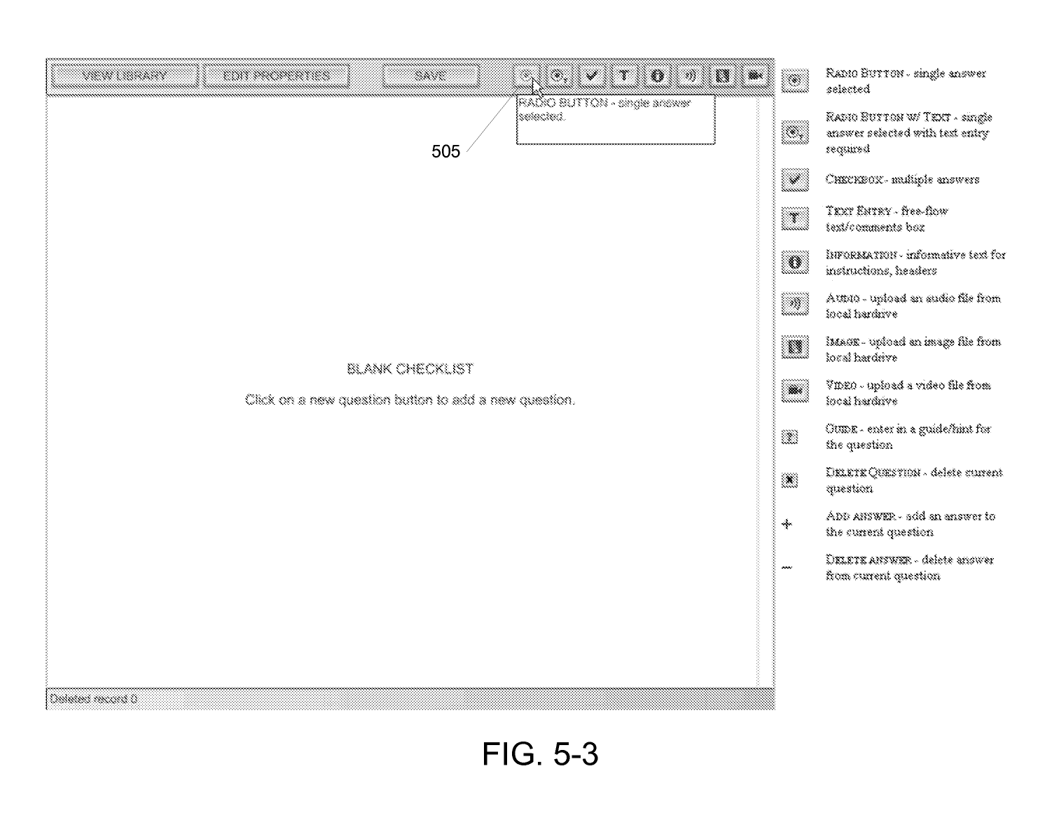

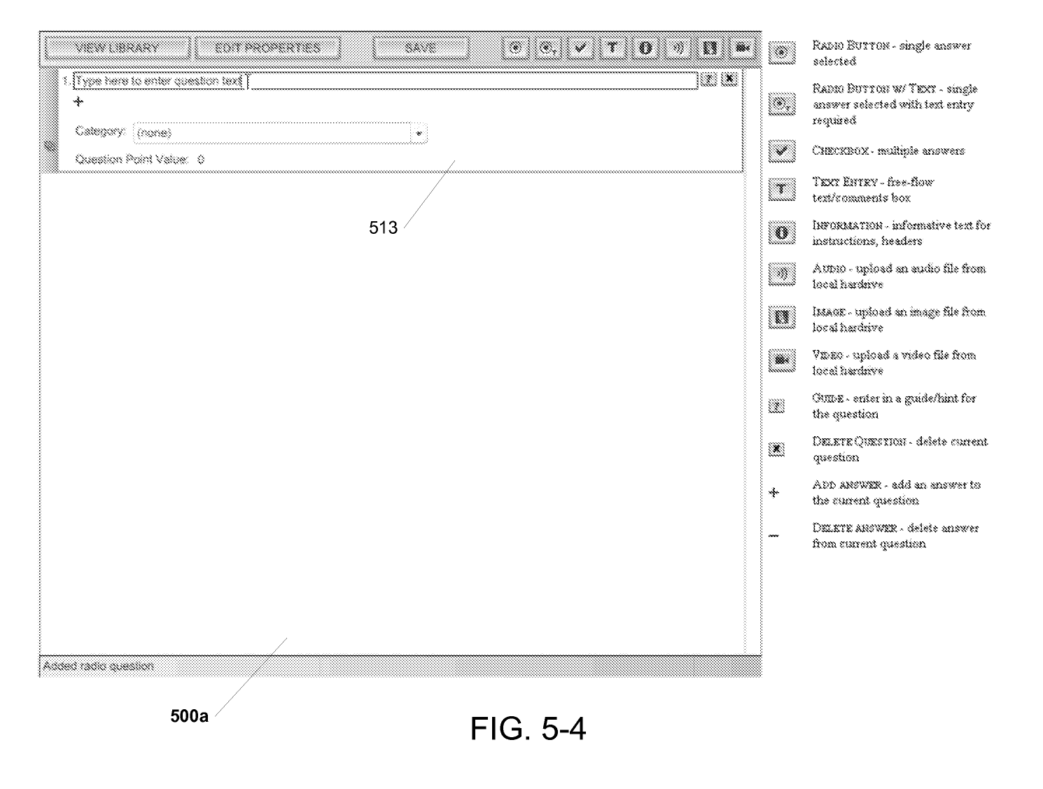

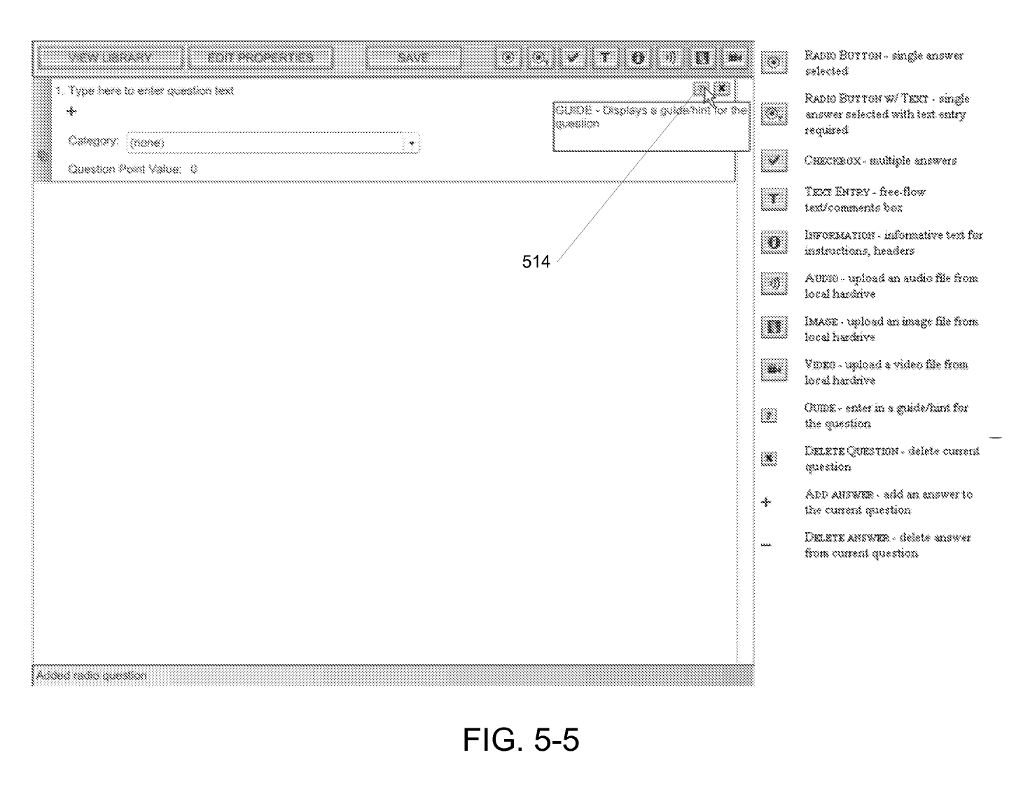

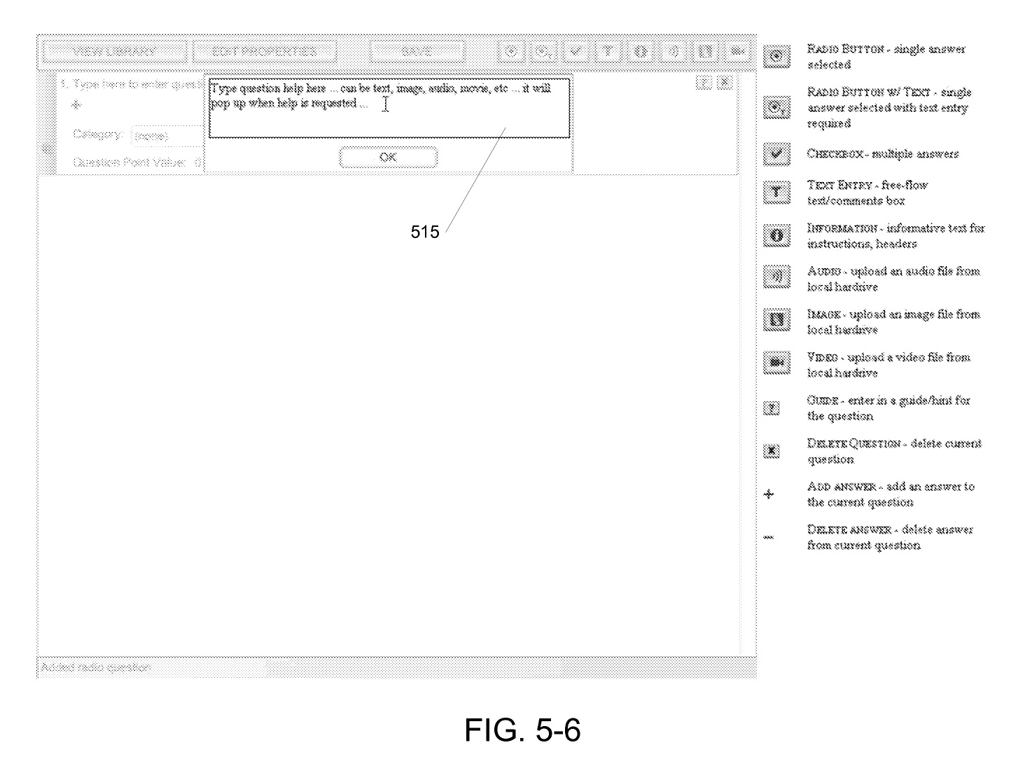

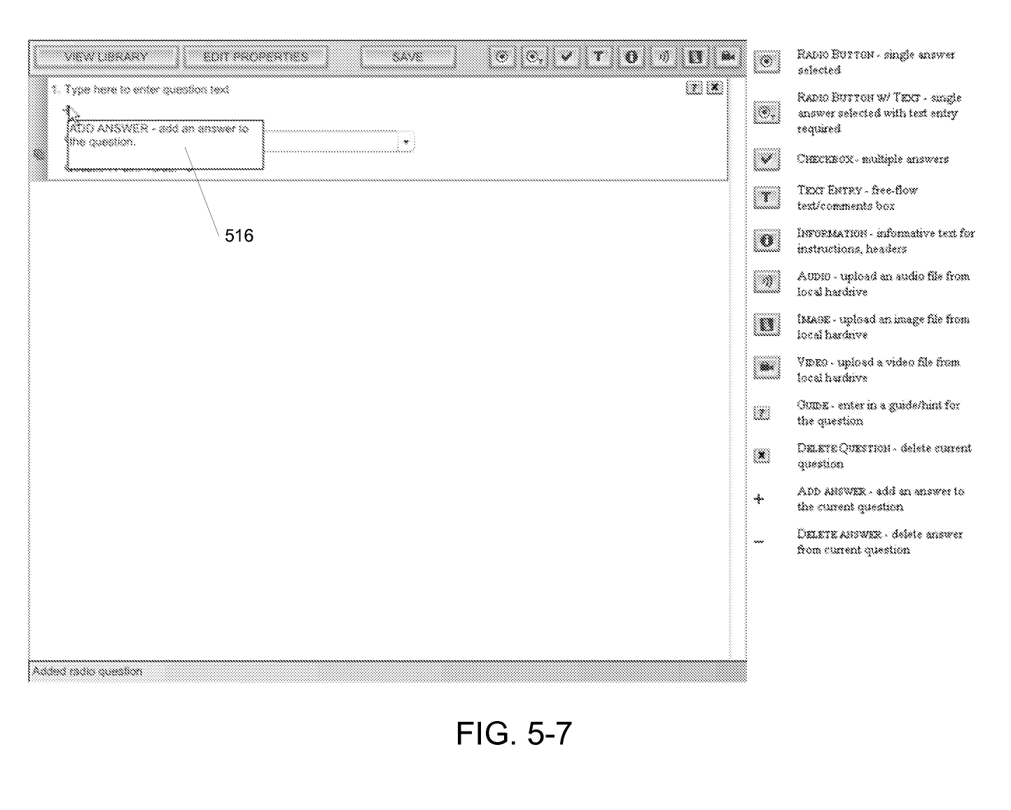

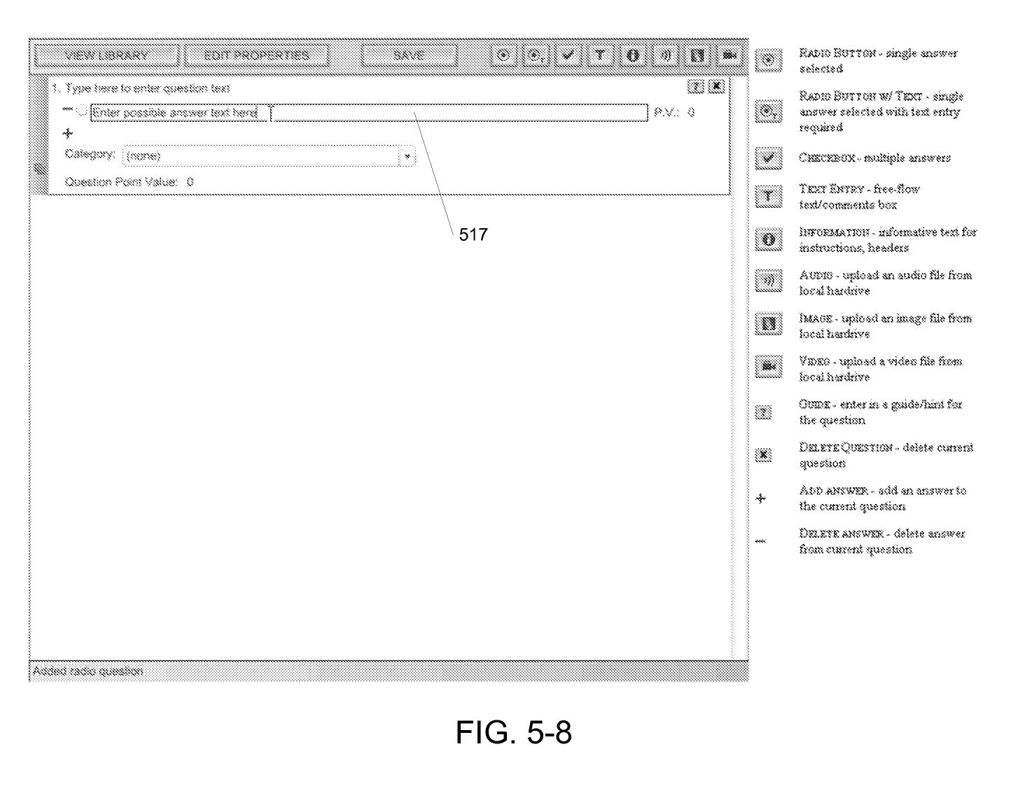

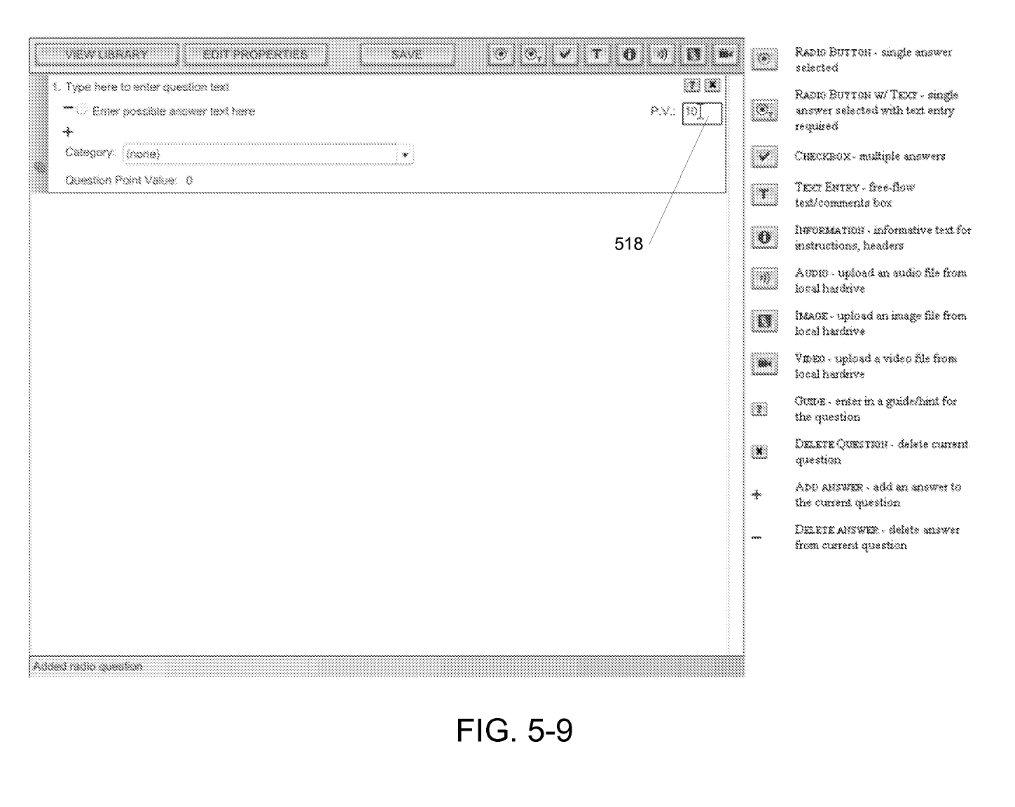

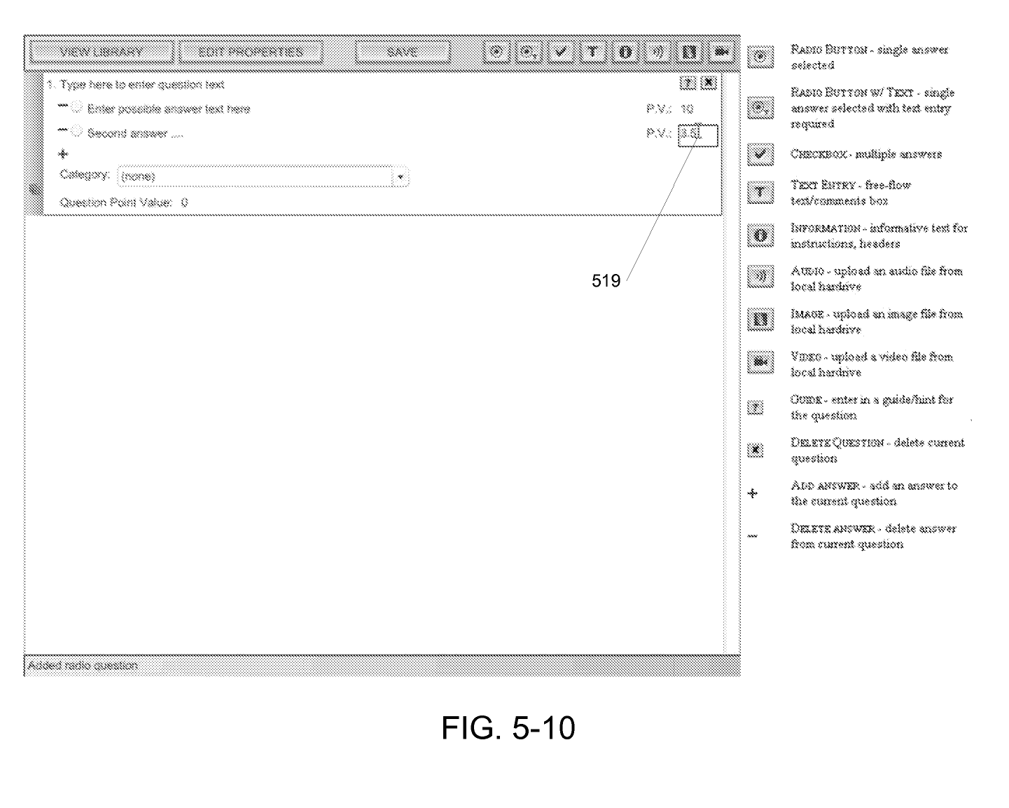

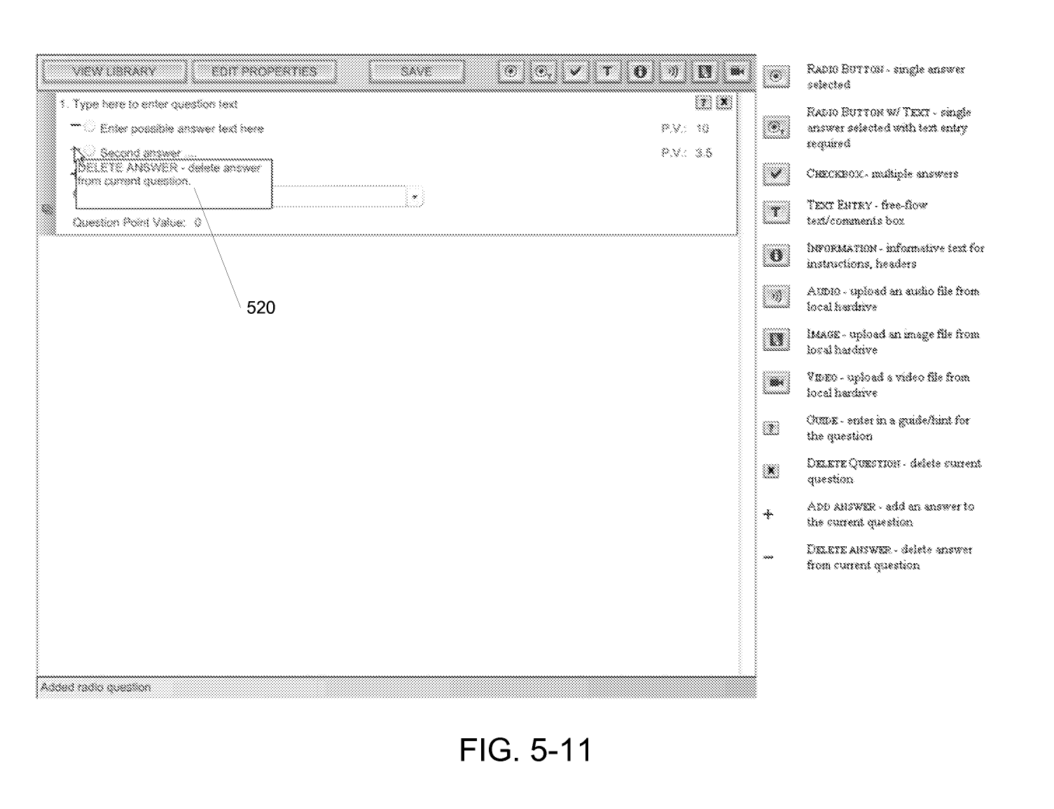

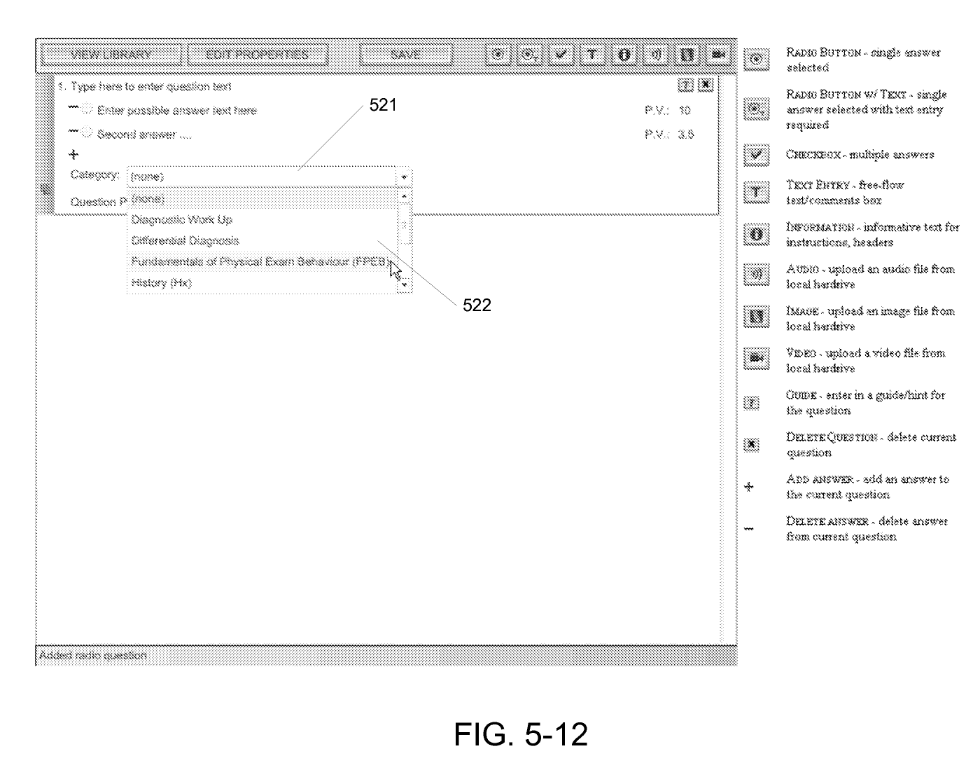

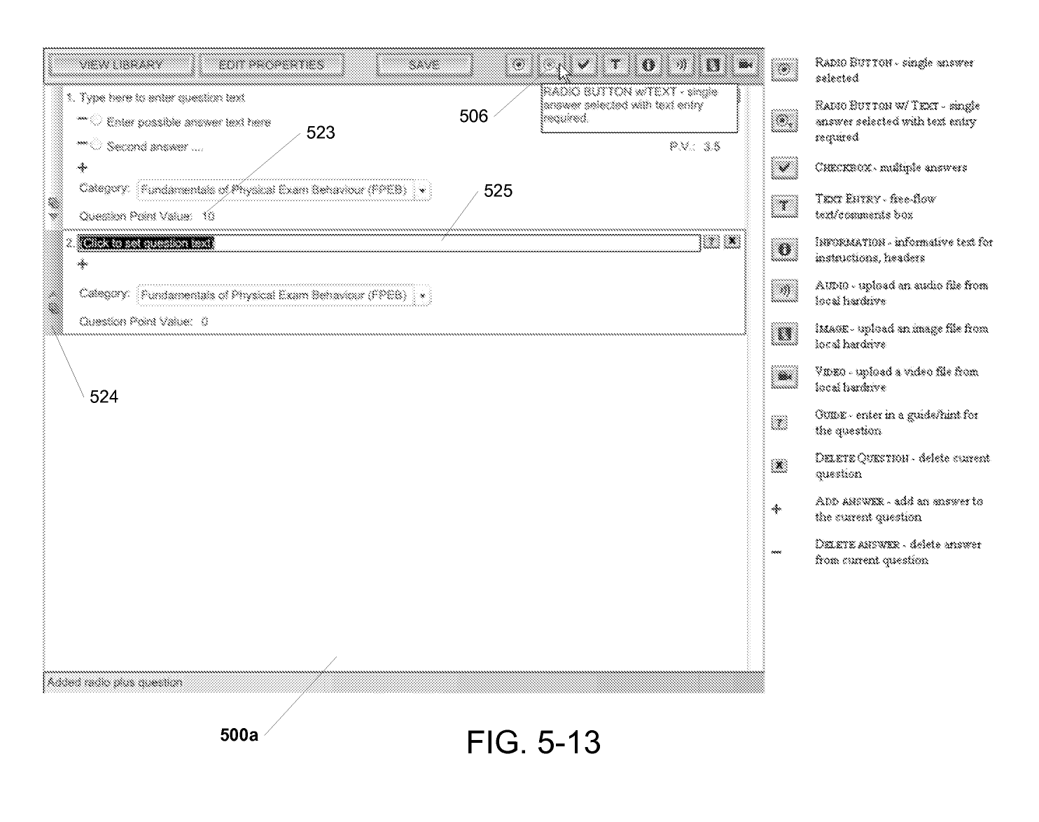

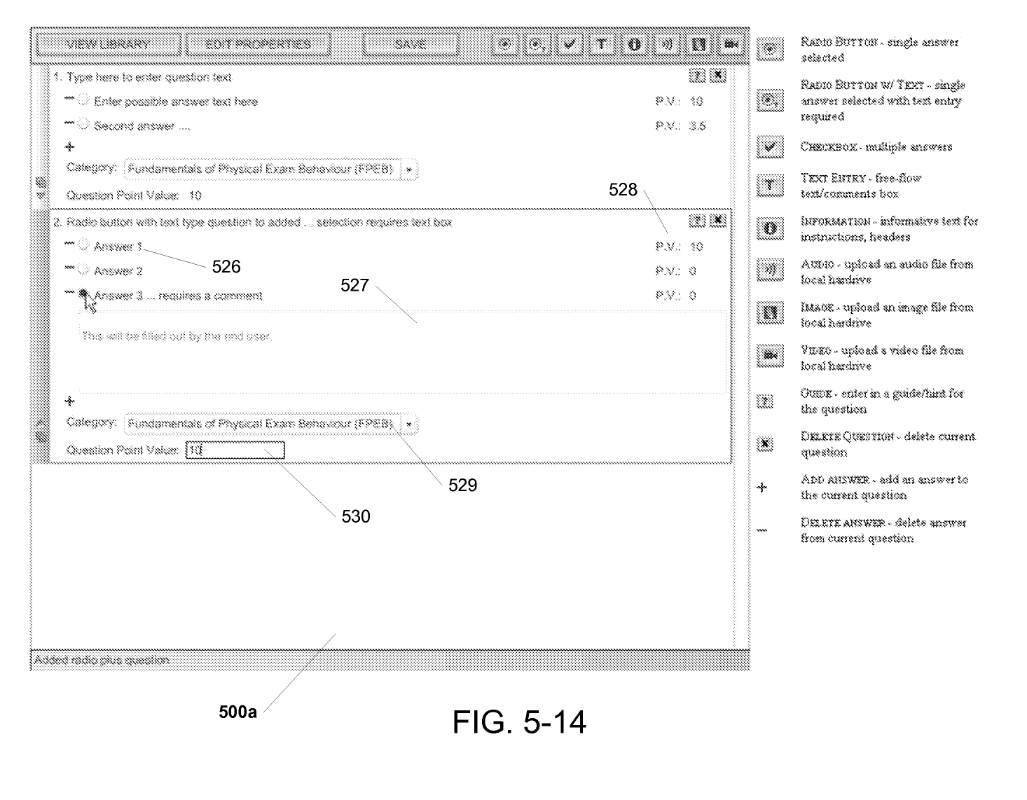

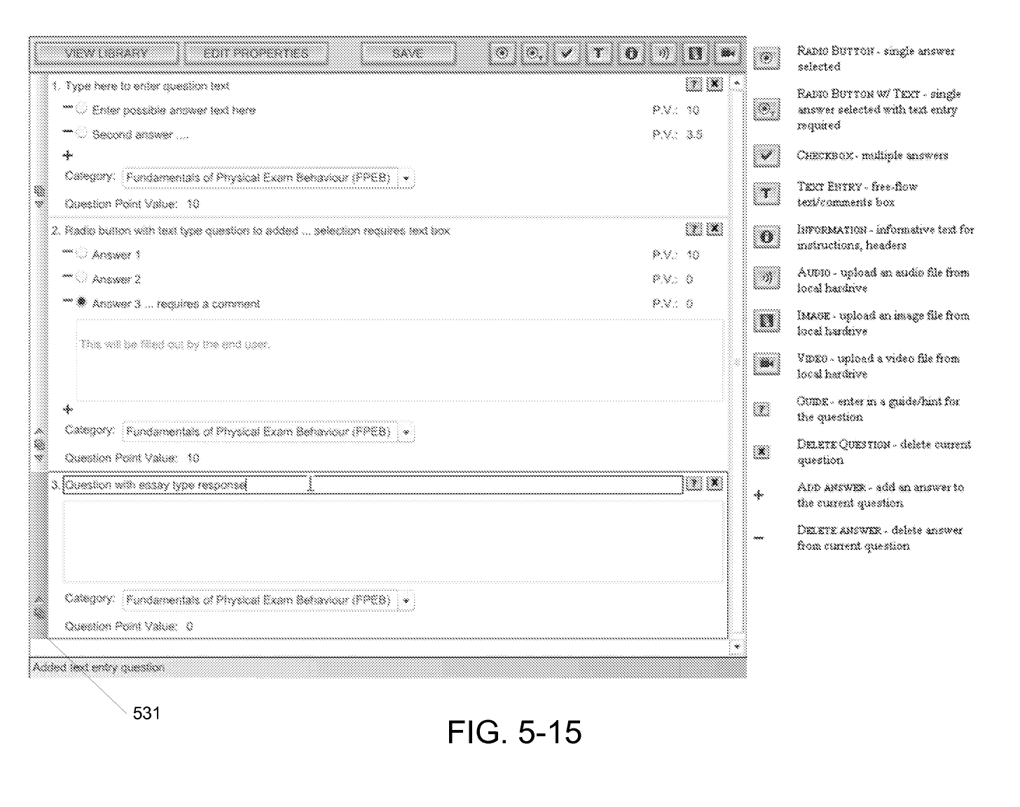

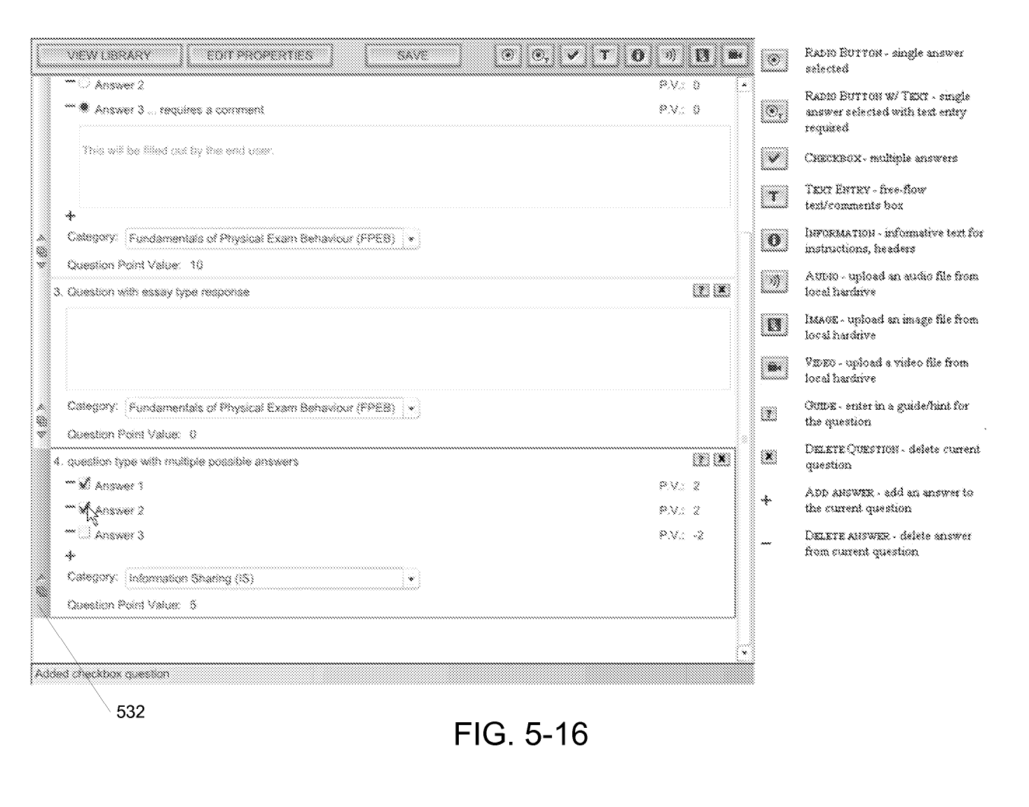

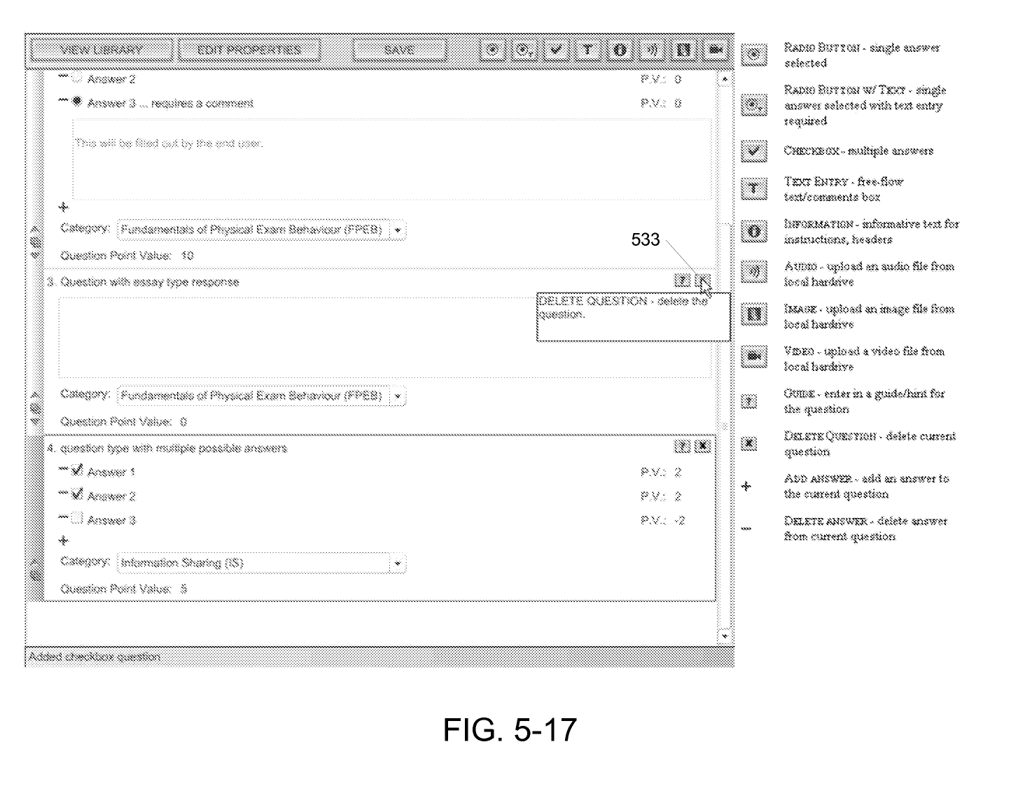

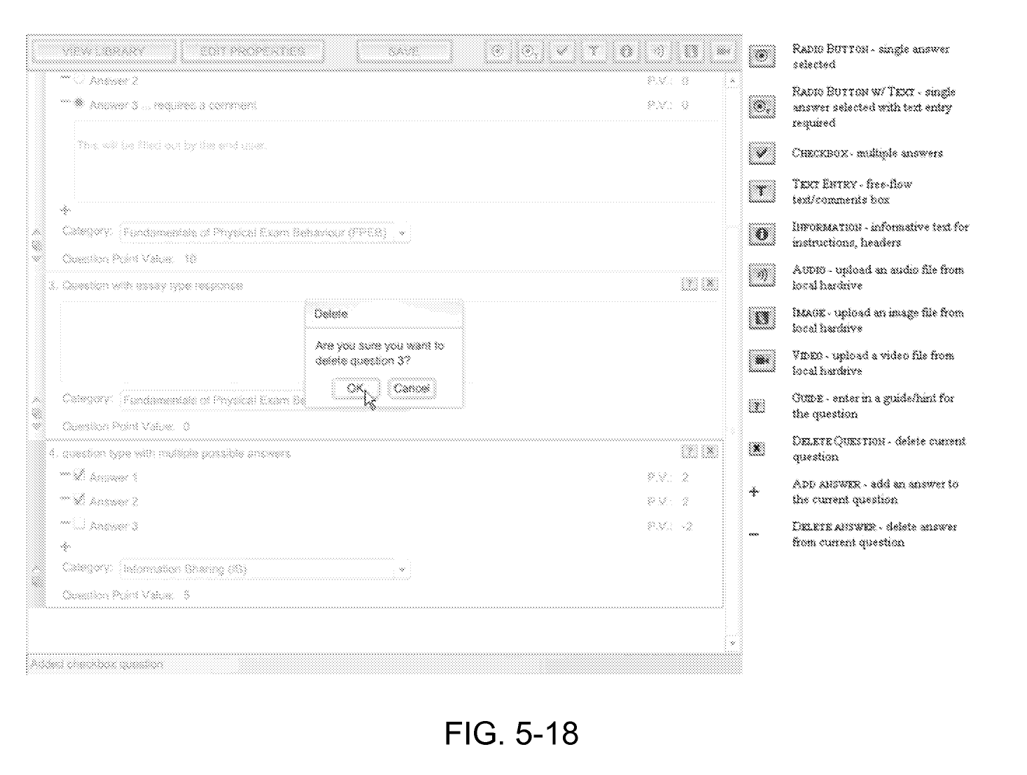

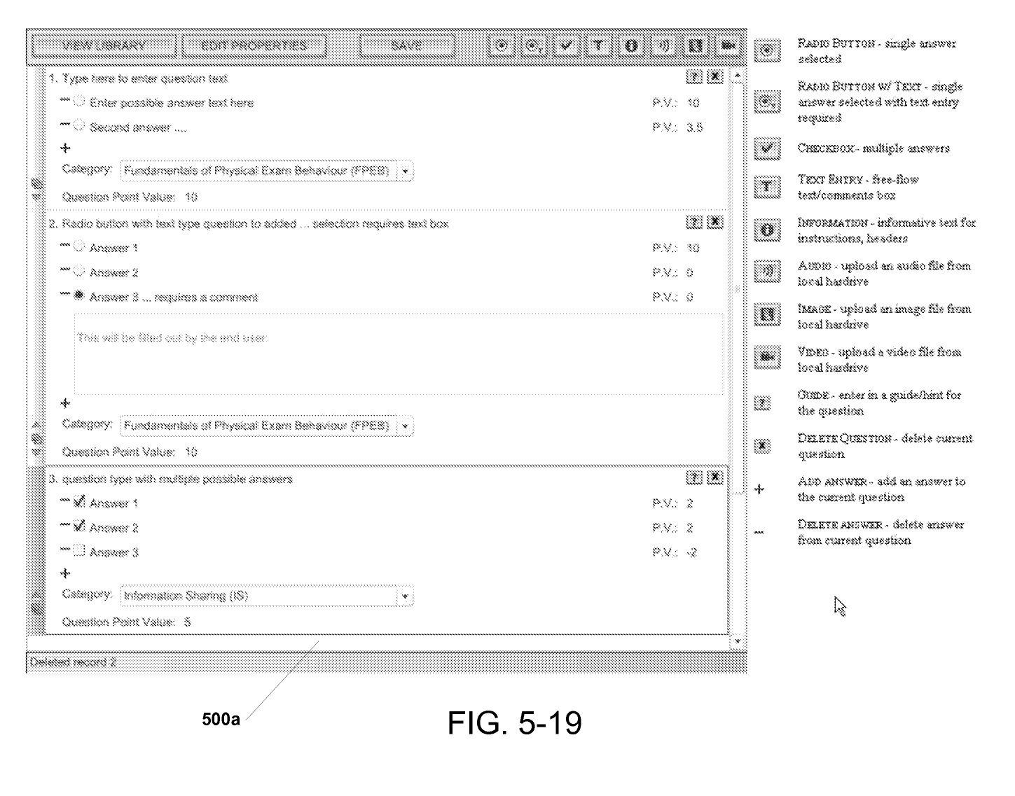

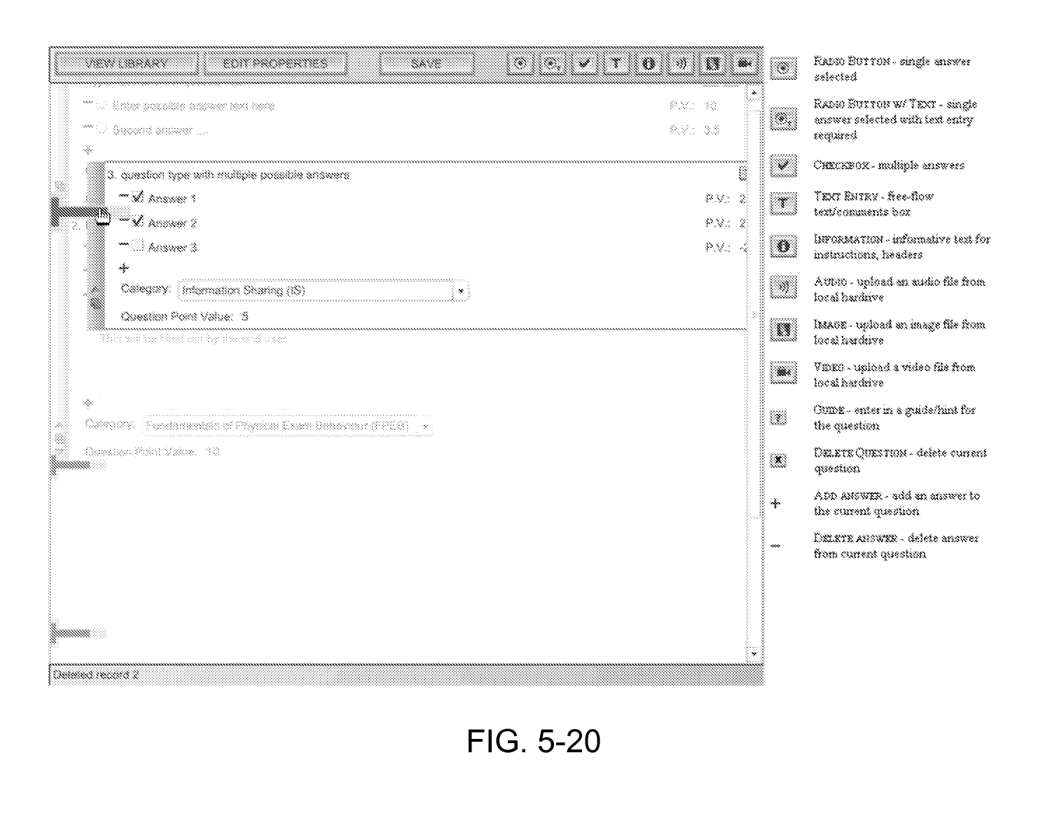

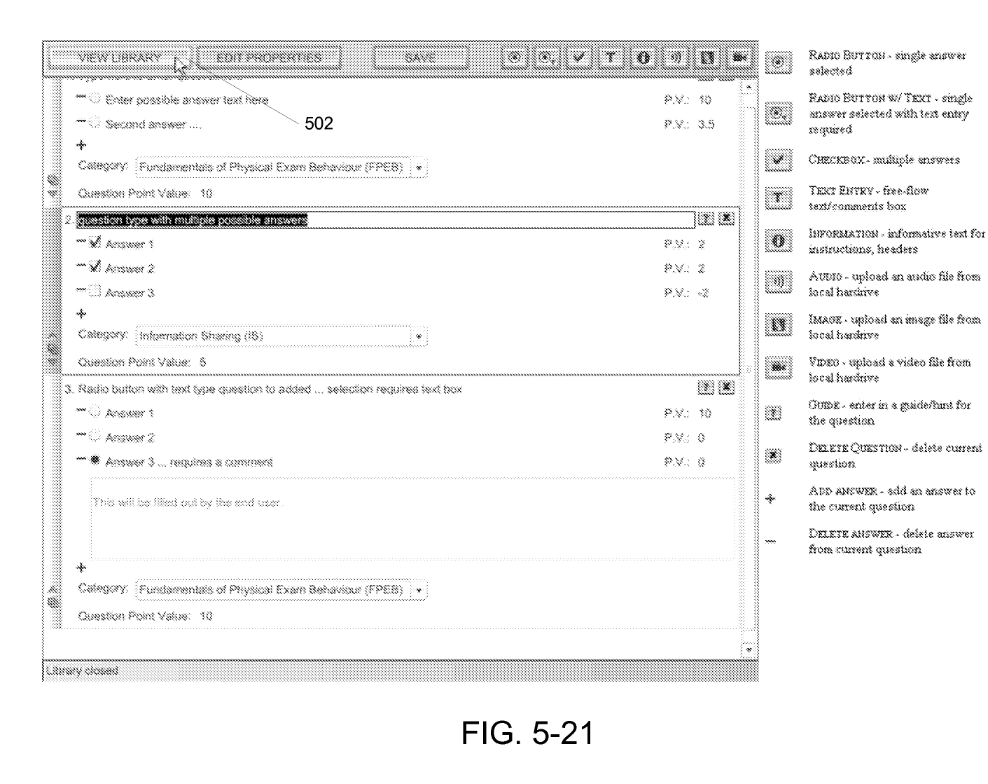

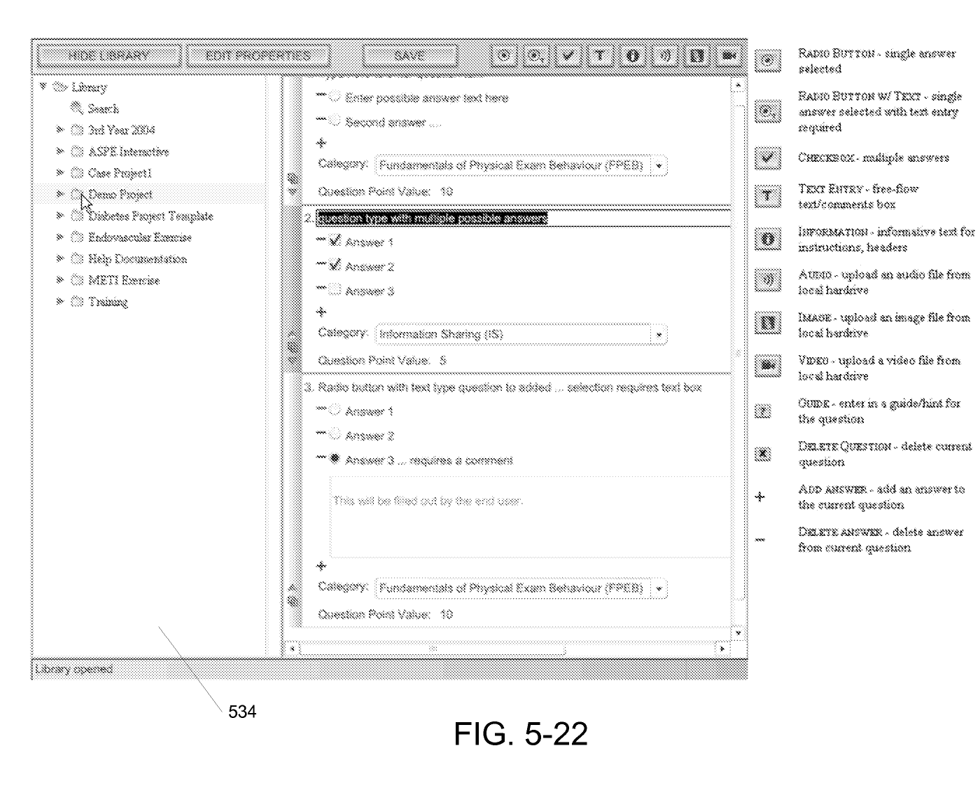

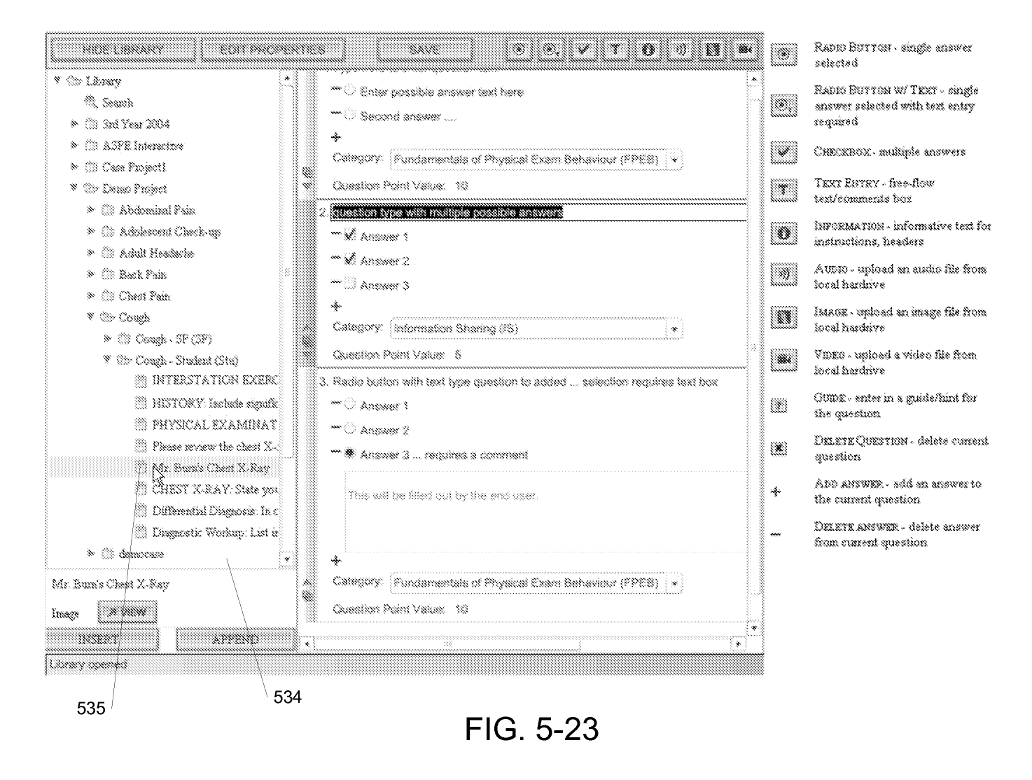

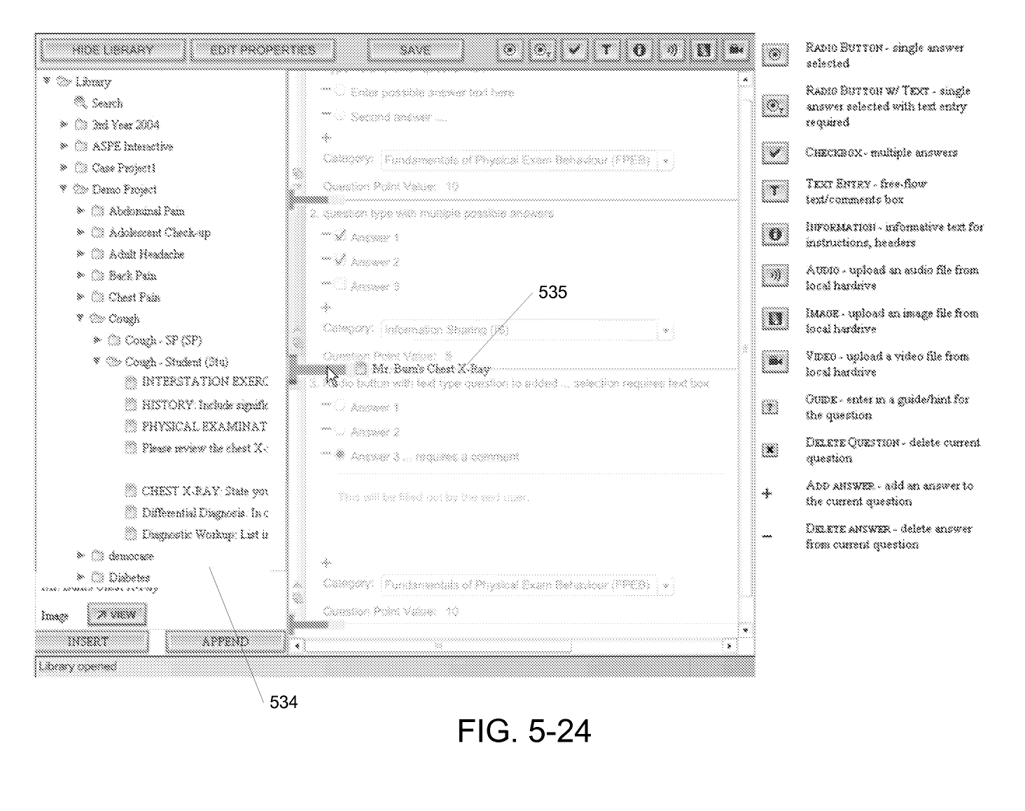

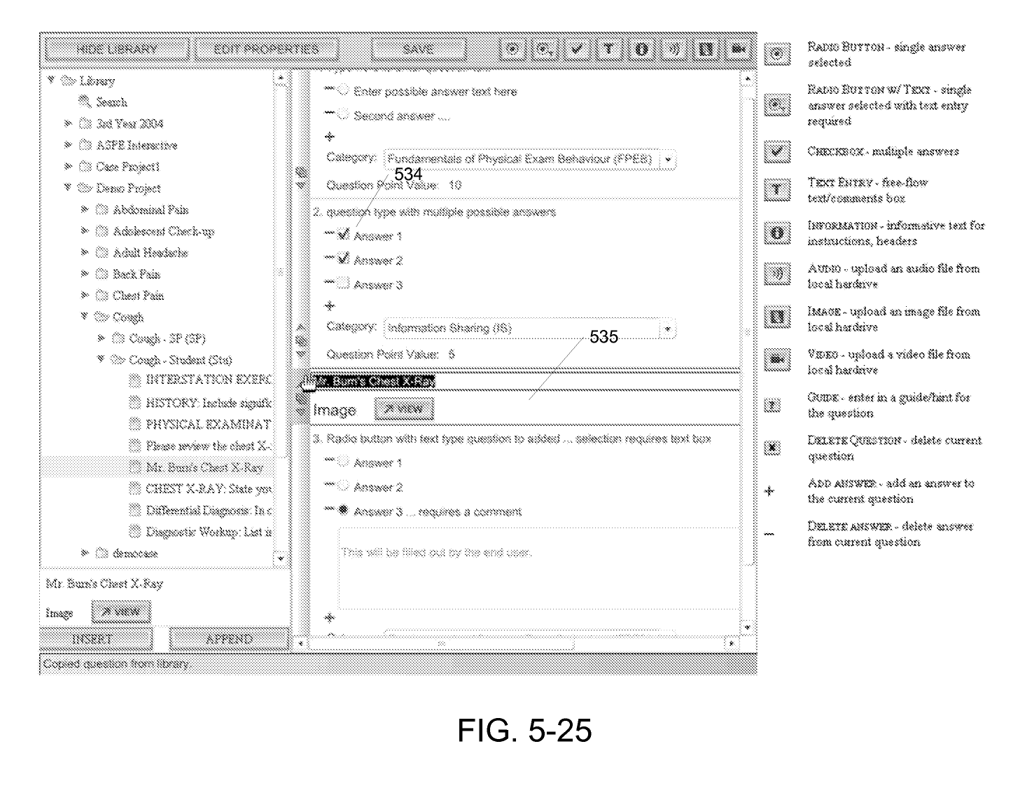

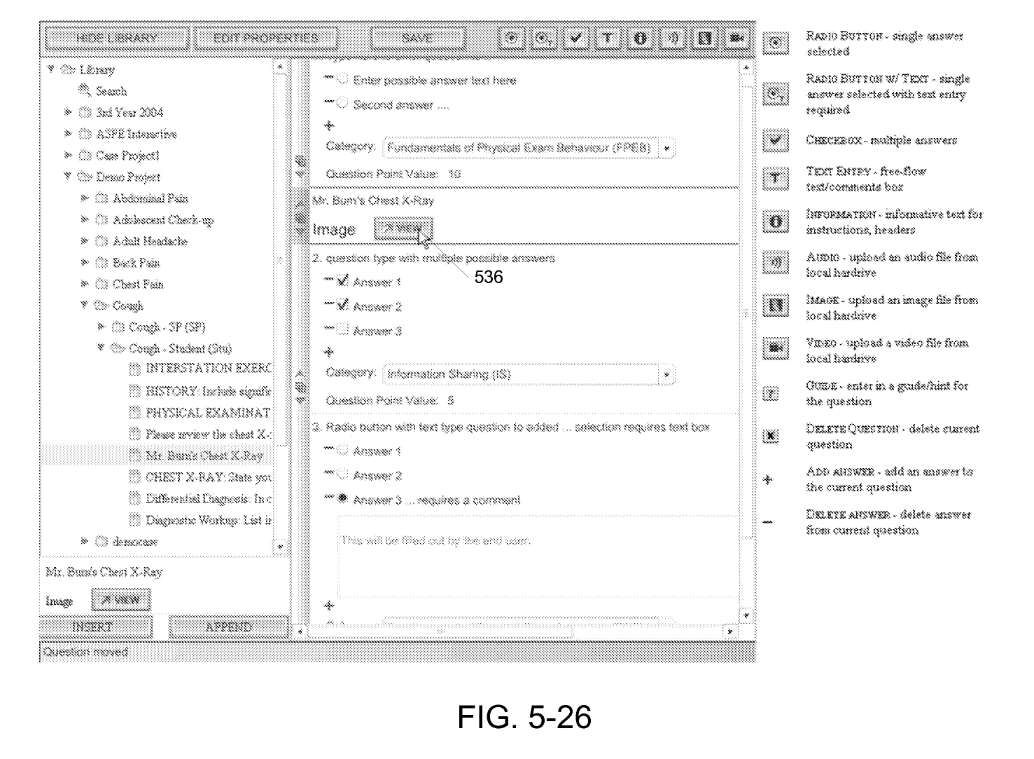

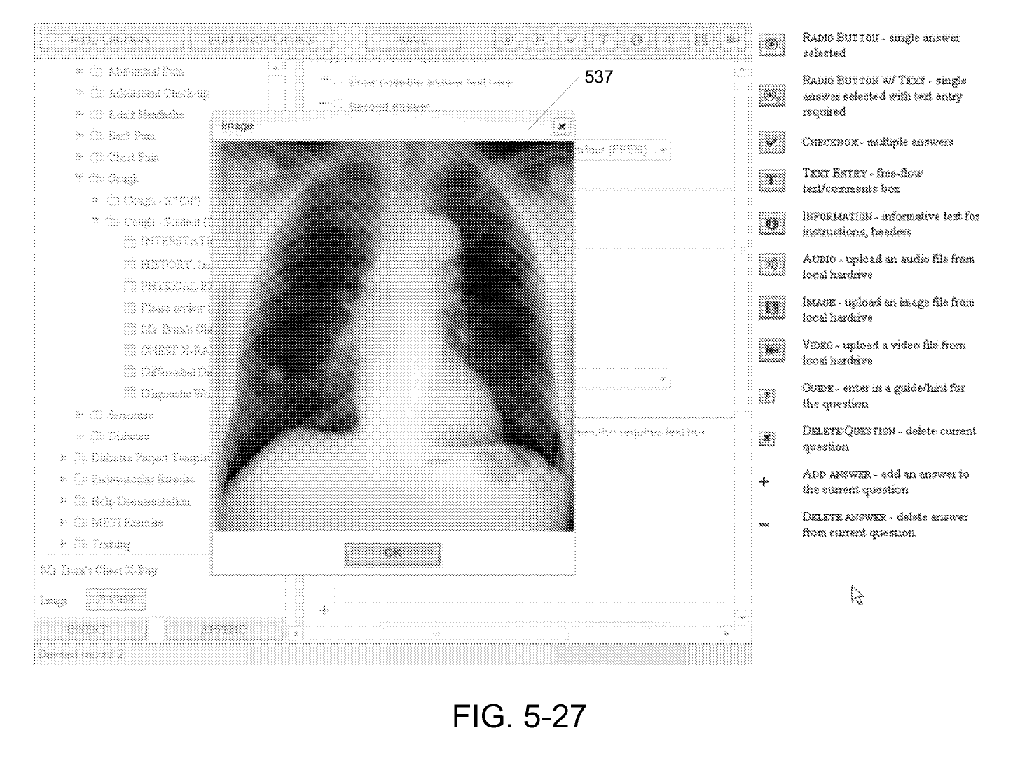

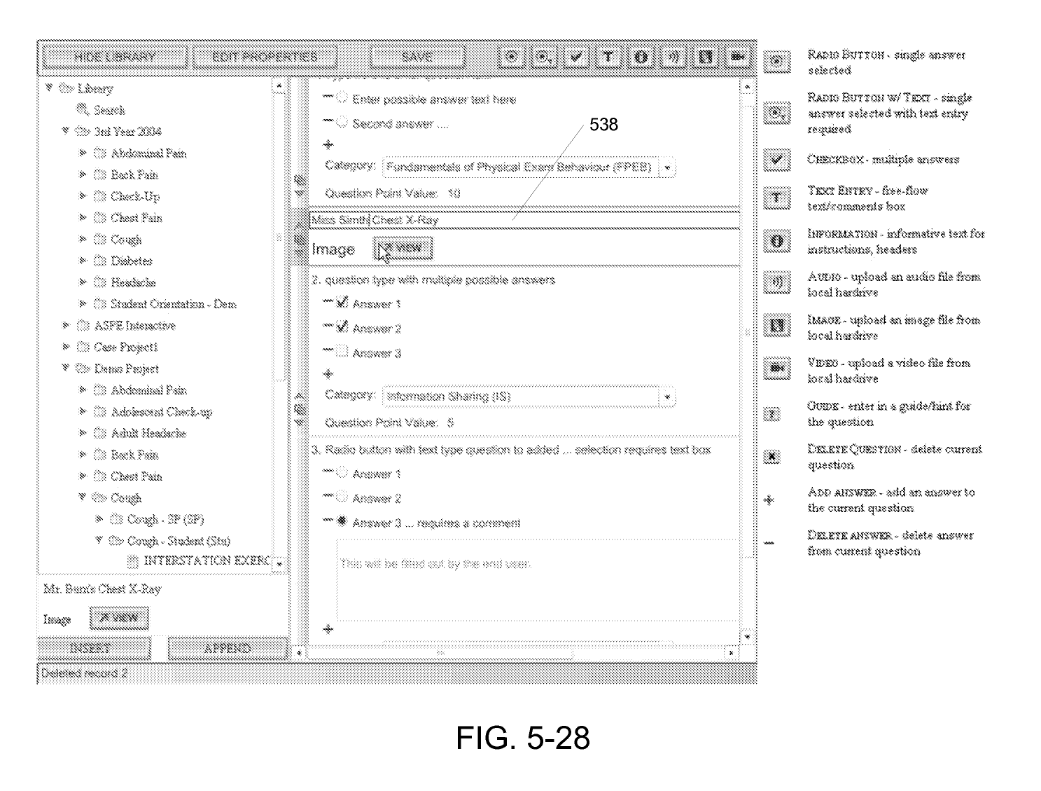

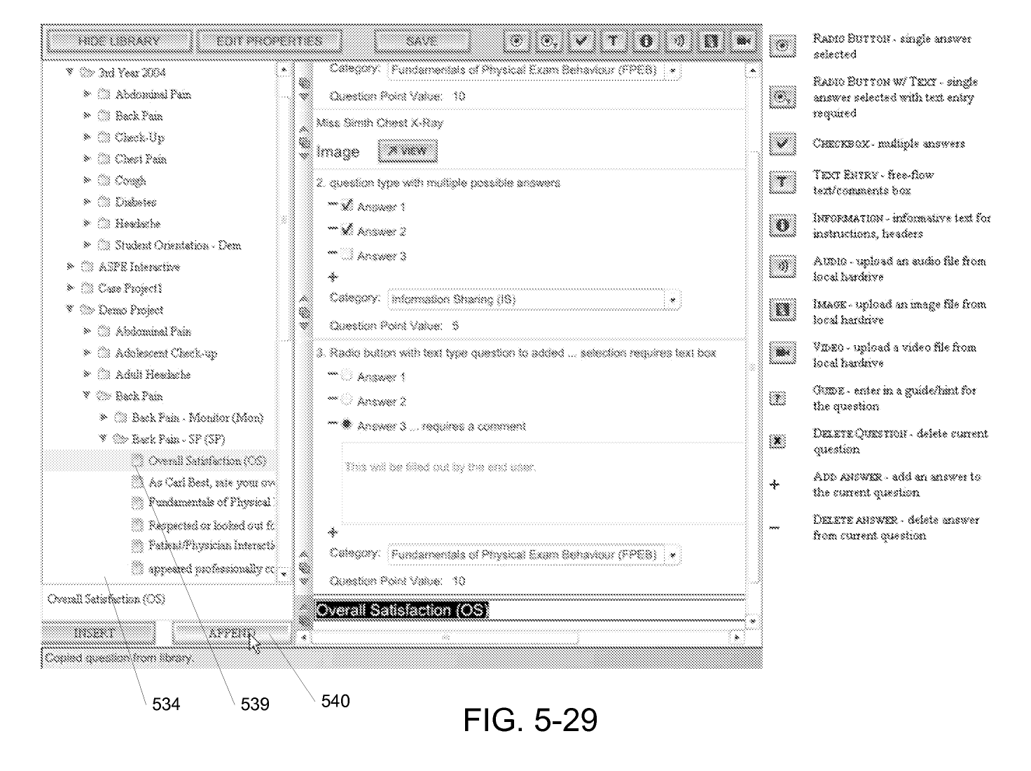

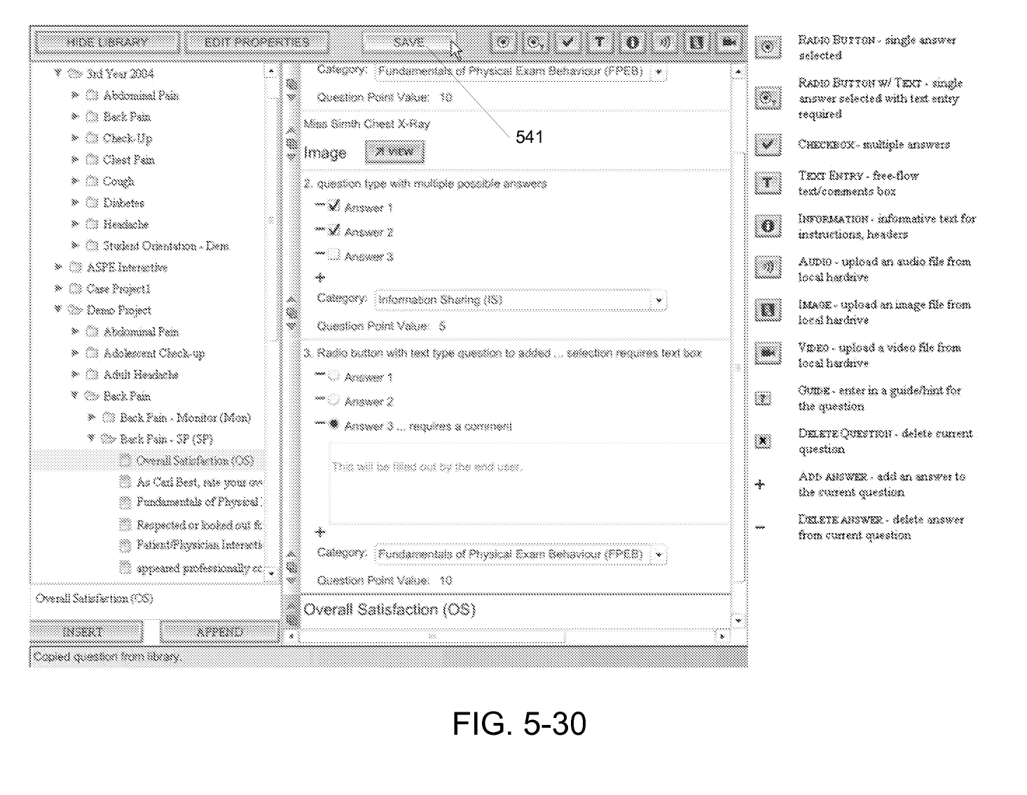

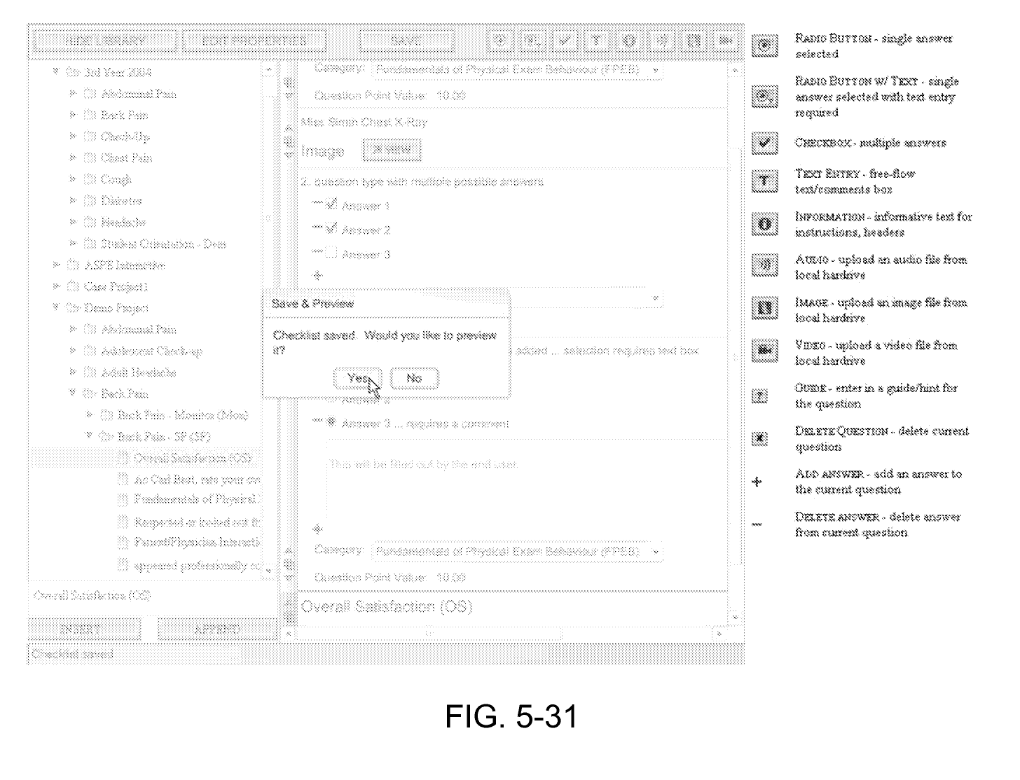

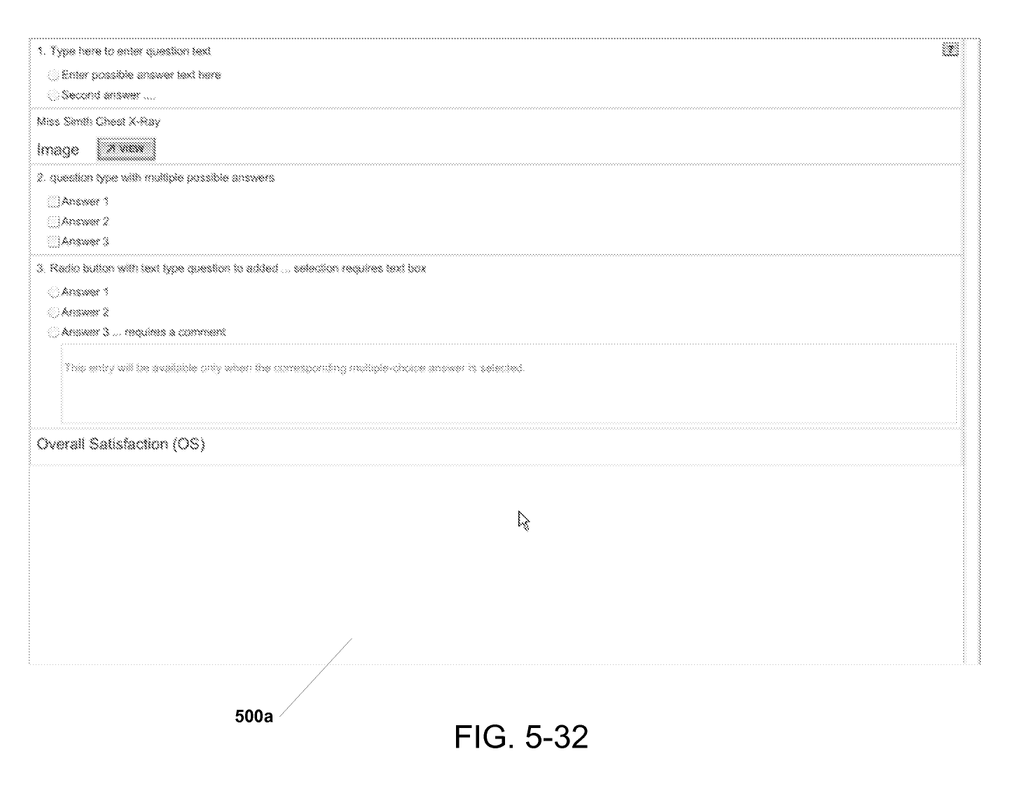

FIG. 4 is a flowchart illustrating a contextual workflow of the checklist builder. FIGS. 5-1 through 5-32 illustrate example checklist builder interface screens displayed through the browser 102 at the client 101. Referring to both FIGS. 4 and 5, a user 103 requests the checklist builder 201 by selecting the “Edit Comments” button 501 for a particular case (step 400; FIG. 5-1). In response, the client 101 sends a request to the server 104 for the checklist builder 201. The server 104 downloads the checklist builder 201 to the client 101 as a software component (step 401). When the client 101 executes the checklist builder software component, the checklist builder interface is displayed through the browser 102 (step 402; FIG. 5-2). A user 103 can add a question to the checklist, modify a question in the checklist, reorder the questions in the checklist, or copy a question from a library of checklists.

In the exemplary embodiment, the checklist builder interface comprises a checklist display section 500a and a menu section 500b. As a user creates the checklist, the checklist display section 500a displays the checklist as it would be seen by a user filling out the checklist, i.e., in a WYSIWYG environment. The menu section 500b includes a first set of buttons 502-504 and a second set of buttons 505-512. The first set of buttons include the View Library button 502, Edit Properties button 503, and Save button 504. The View Library button 502 allows the user 103 to view a tree of existing checklists and their questions within the system. This allows the user 103 to re-use existing checklist data. This function is described in more detail later. The Edit Properties button 503 allows a user to edit general checklist information. When the Properties button 503 is selected, a panel (not shown) is displayed on the client 101 with information that can be changed. The Save button 504 is used to save the current contents of the checklist. Once a checklist is saved, a user can preview the checklist.

The second set of buttons pertains to the adding of questions to the checklist. It includes a Radio button 505, a Radio button with Text button 506, a Checkbox button 507, a Text Entry button 508, an Information button 509, an Audio button 510, an Image button 511, and a Video button 512.

The Radio button 505 adds a multiple choice question with a single answer. The Radio Button with Text button 506 adds a multiple choice question with a single answer and with text entry required. The Checkbox button 507 adds a question with multiple answers. The Text Entry button 508 adds a question with free-flow text or comments box. The Information button 509 adds informative text for instructions or headers. The Audio button 510 uploads an audio file stored locally at the client 101. The Image button 511 uploads an image file stored locally at the client 101. The Video button 512 uploads a video file stored locally at the client 101.

A user 103 chooses to add a question (step 403) by selecting one of the second set of buttons 505-512. The client 101 receives the selection of the type of question indicated by the selected button (step 404). The client displays a template for the question type (step 405). The client 101 then receives the question parameters entered by the user (step 406). Question parameters include the question text, the answers, the question category, points values for each possible answer, and a point value for the question.

The question category identifies the type of skill being assessed. By applying a category to a question, the questions are grouped together and can be reported as a score for a skills area. Thus, questions can be associated across cases by the question category, and an overall score for the clinical skills area for the exam can be determined.

Two types of point values can be assigned for each question: response point value and question point value. The response point value indicates how many points are awarded if a particular possible answer response is chosen. The question point value indicates how many points are awarded if the question is answered correctly. The question point values are added to determine the overall score on the checklist.

FIGS. 5-3 through 5-12 illustrate example checklist builder interface screen displays for the adding of a question to a checklist. Referring again to both FIGS. 4 and 5, for example, assume that the client 101 receives the selection of the Radio button 505 (FIG. 5-3). The client 101 displays a radio question template 513 (step 405; FIG. 5-4) in the checklist display section 500a and receives the question text entered by the user 103. The user 103 can select the Guide button 514 (FIG. 5-5) and a text box 515 is displayed (FIG. 5-6) into which the user 103 enters the help text for that question. The help text would contain additional information that would be linked to the question and would be accessible to users who are filling out the checklist.

To add a possible answer for the question, the user 103 selects an Add Answer button 516 (FIG. 5-7). A text box 517 is displayed (FIG. 5-8) into which the user 103 enters the possible answer text. The user 103 further assigns the response point value 518 for that possible answer (FIG. 5-9). The user 103 repeats these steps for the second possible answer and assigns a response point value 519 for the second possible answer (FIG. 5-10). With each possible answer, a Delete Answer button 520 is displayed (FIG. 5-11), which is selected if the user 103 wishes to delete a possible answer.

The user 103 selects the Category text box 521 (FIG. 5-12) to assign a question category. Optionally, a drop down menu 522 of predefined categories can be provided, or the user 103 can enter a user-defined category. The user 103 further enters a question point value 523 (FIG. 5-13). When the question parameters have been received, the checklist builder interface displays the checklist with the changes in the checklist display section 500a (step 422).

As another example, assume that the client 101 next receives a selection of the Radio Button with Text button 506 (step 404; FIG. 5-13). The client 101 displays a radio button with text question template 524 in the checklist display section 500a (step 405; FIG. 5-13) and receives the question text 525 entered by the user 103. The client 101 then receives the question parameters (step 406; FIG. 5-14), including the possible answers 526, a possible answer with text required 527, the response point value for each possible answer 528, the question category 529, and the question point value 530. When the question parameters have been received, the client 101 displays the checklist with the changes in the checklist display section 500a (step 422).

As other examples, FIGS. 5-15 and 5-16 illustrate example checklist builder interface screens displayed for adding a Text Entry question 531 and a checkbox question 532, respectively, in a similar manner as above.

Referring again to FIG. 4, when modifying a question (step 407), if the modification is to delete a question (step 408), then the question is removed from the checklist (step 409). Otherwise, the client 101 receives modifications to one or more of the question parameters (step 410). For example, the client 101 receives the user's selection of a Delete Question button 533 for question 3 in the checklist (FIG. 5-17). In response, the client 101 requests confirmation from the user 103 to delete this question (FIG. 5-18). If confirmation is received, the client 101 removes question 3, and the remaining questions are automatically renumbered and displayed in the checklist display section 500a (step 422; FIG. 5-19).

When reordering the questions (step 411), the client 101 receives a selection of a question (step 412). For example, the user 103 can select question 3 (FIG. 5-20). The checklist builder interface then allows the user 103 to drag and drop question 3 to a position between question 1 and 2 (step 413). The questions are then automatically renumbered to reflect the new order and displayed in the checklist display section 500a (step 422).

When copying a question (step 414), the client 101 receives a selection to view the library (step 415). In the exemplary embodiment, each time a checklist item is created, it is stored in the library. This allows for the reuse of content from previous checklists to expedite the checklist creation process. The library is organized in the application hierarchy of Project, Case, Checklist, and Question.

For example, the View Library button 502 is selected by the user 103 (FIG. 5-21). The client 101 then displays a preview of the questionnaire library 534 (step 416; FIG. 5-22). The questionnaire library tree 534 can be expanded until individual questions from a particular checklist are displayed (FIG. 5-23). For example, the library tree is expanded so that the question from the checklist “Cough-Student (Stu)” in case “Cough” in “Demo Project” is displayed. A question is then selected by the user 103, and the client 101 copies the selected question at the location indicated by the user 103 (step 417). For example, the question “Mr. Burn's chest X-Ray” 535 can be dragged and dropped to a location between questions 2 and 3 (FIG. 5-24 and FIG. 5-25). Any assets associated with the question are also copied (step 418). For example, an image of a chest x-ray is associated with the question “Mr. Burn's Chest X-Ray”, and this image is copied along with the question (FIG. 5-26). The user 103 can request to view the image by selecting the View button 536. In response, the client 101 displays the image 537 (FIG. 5-27). If the copied question is to be modified (step 419), the client 101 receives the modification to one or more of the question parameters (step 420). For example, the text content 538 of the question can be changed from “Mr. Burn's Chest X-Ray” to “Mrs. Smith Chest X-Ray” (FIG. 5-28).

Optionally, a user 103 can highlight/select a specific question, such as the “Overall Satisfaction” question 539 (FIG. 5-29), in the questionnaire library tree 534 and select the Append button 540. The client 101 copies or appends the highlighted question to the checklist. When the user 103 selects the Save button 541 (FIG. 5-30), the client 101 displays a request for confirmation (FIG. 5-31). Upon receiving the confirmation, the client 101 saves the checklist locally (step 421) and displays the checklist with the copied question in the checklist display section 500a (step 422; FIG. 5-32).

After the user is done creating the checklist (step 422), the client 101 sends the checklist to the server 104 in a single request (step 423). The server 104 parses the checklist and stores it in the user and results database 107.

The checklist builder 201 provides the user with a WYSIWYG environment for the user to increase the intuitiveness of the builder's use, where the checklist is displayed as it would be seen by a user when filling out the checklist. Such an environment enhances the experience of the user by providing a more intuitive interface with fewer popup windows. The checklist data is stored locally until the checklist is complete. The client then sends the checklist data to the server in a single request. In this manner, communications between the client and the server are significantly reduced over the prior art, increasing the efficiency of the system.

Checklist Submission

During or after an assessment, a user 103 fills out a checklist appropriate for the user's role at the client 101. In filling out the checklist, the user selects answers for each question in the checklist. The checklist with the selected answers is then submitted by the client 101 to the server 104.

FIG. 6 is a flowchart illustrating the checklist submission in an exemplary embodiment of the invention. The server 104 first receives the checklist with selected answers from a user 103 (step 601). The server 104 stores the user information and case data (step 602). Case data can include a video of the assessment. The user information can be stored in the user and results database 107, and the video can be stored in the video archive 109. The selected answers for each question in the checklist are also stored, in the user and results database 107, without scoring the questions (step 603). The selected answers are associated with the user information and the case data. The scoring of the questions occurs when a report is generated, as described later with reference to FIG. 7.

By storing case data along with the checklist data, these data are more easily assessable to a user when reviewing the completed checklist. The user need not access multiple systems separately to view the data. By storing the selected answers without scoring the questions, the flexibility in report generation will be increased.

In the exemplary embodiment, upon submission of a checklist with selected answers, the data is validated. The validation process checks for inconsistent data or missing data. Missing checklist data can be identified for an entire project or cases. In addition, most of the statistical analysis can be done in the same application instead of multiple systems.

Reporting Tool

Various reports can be generated for the data stored in the user and results database 107 by the reporting tool 203. The reporting tool 203 is integrated with the checklist builder 201. Further, the stored answers are not scored until a report is generated. Because of this integration and because the answers are not scored prior to report generation, a user 103 can return to the checklist builder interface at the client 101 from the reporting tool 203 to modify question parameters for any question in the checklist. A report can then be generated according to the modified question parameters.

FIG. 7 is a flowchart illustrating the reporting generating process in an exemplary embodiment of the invention. Upon receiving a request to generate a report for the data stored in the user and results database 107, the reporting tool 203 retrieves the data and scores the selected answers and applies any category filters relevant to the report (step 701). If the category for any checklist question is to be modified (step 702), the user 103 is automatically returned to the checklist builder interface at the client 101. Using the checklist builder interface, the category of any question in the checklist can be modified in the manner described above. Once completed, the user is automatically returned to the reporting tool. The category filters are then reapplied (step 701), and a report is generated (step 706).

If a response points value or a question point value is to be changed (step 704), the user 103 is returned to the checklist builder interface at the client 101. Using the checklist builder interface, the response point or question point values of one or more questions in the checklist are modified, in the manner described above. The selected answers are then rescored (step 701), and a report is generated (step 706).

In the exemplary embodiment, checklist scores are a summation of all the question point values that were assigned during the checklist building process. Individual checklist scores depend on the student's performance on that case. The scores are automatically calculated, both by case and by category.

Checklists with question types “Radio with Text” and “Text Only” require scoring by faculty or staff. They do so by filling out faculty checklists. Answer keys can be developed so that the faculty would know how to score open-ended questions consistently. The faculty checklist is then combined with the student checklist point values in reporting to produce a precise test score for the student.

Once a report is generated, the results are displayed at the client 101, along with any display options (step 707). Optionally, the data can be exported (step 708) to third party applications (step 709) for further data analysis (step 710).

A method and system for improved skills assessment have been disclosed. The improved skills assessment tool hosted by a server downloads a checklist builder to a client as a software component. When the client executes the checklist builder software component, the checklist builder interface is displayed through a browser residing locally at the client. A user creates checklist data through the checklist builder interface. The checklist builder interface provides the user with a WYSIWYG environment to increase the intuitiveness of the builder's use, where the checklist is displayed as it would be seen by a user when filling out the checklist. The checklist data is stored locally until the checklist is complete. The client then sends the checklist data to the server in a single request. In this manner, communications between the client and server are significantly reduced over the prior art, increasing the efficiency of the system.

When the skills assessment tool receives a submission of a completed checklist, user information and case data are stored to make this data more assessable to a user when reviewing the completed checklist. Further, the selected answers are stored without scoring. The selected answers are further associated with the user information and case data. The scoring of the selected answers occurs during report generation by the reporting tool of the skills assessment tool. The reporting tool is integrated with the checklist builder, so that a user may be returned to the checklist builder interface at the client to modify question parameters for any question in the checklist. The selected answers are then rescored and the category filters reapplied, and the report is generated. Thus, the reporting tool generation is truly performed in real-time.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for allowing creation of a checklist for skills assessment at a client, wherein the client includes a browser residing locally to the client, wherein the client is in communication with a server, comprising:
(a) sending a request for a checklist builder from the client to the server;
(b) receiving by the client the checklist builder as a software component;
(c) executing the checklist builder software component at the client, and displaying a checklist builder interface through the browser at the client;
(d) receiving checklist data for the checklist through the checklist builder interface at the client, wherein the checklist data is stored locally to the client;
(e) receiving an indication that the checklist is complete through the checklist builder interface at the client; and
(f) sending the stored checklist data from the client to the server in a single request.

2. The method of claim 1, wherein the receiving (d) comprises receiving checklist data for adding a question to the checklist, comprising:
(d1) receiving a selection of a type of the question;
(d2) displaying a template for the question type; and
(d3) receiving question parameters for the question.

3. The method of claim 2, wherein the question parameters comprise a text for the question.

4. The method of claim 2, wherein the question parameters comprise a category, wherein the category identifies a type of skill being assessed by the question.

5. The method of claim 2, wherein the question parameters comprise at least one possible answer for the question.

6. The method of claim 2, wherein the question parameters comprise a plurality of possible answers for the question, wherein each possible answer comprises a response point value indicating a number of points awarded for choosing the possible answer.

7. The method of claim 2, wherein the question parameters comprise a question point value indicating a number of points awarded for answering the question correctly.

8. The method of claim 1, wherein the receiving (d) comprises receiving checklist data for modifying a question in the checklist, comprising:
(d1) determining if the question is to be deleted;
(d2) if so, then deleting the question; and
(d3) if not, then receiving at least one modification to question parameters for the question.

9. The method of claim 8, wherein the question parameters comprises a text for the question, at least one possible answer for the question, a category for the question, a response point value for the at least one possible answer, or a question point value.

10. The method of claim 1, wherein the receiving (d) comprises receiving checklist data for reordering a plurality of questions in the checklist, comprising:
(d1) receiving a selection of one of the plurality of questions; and
(d2) moving the selected question to a location indicated by a user.

11. The method of claim 10, wherein the moving (d2) is performed utilizing a drag and drop function.

12. The method of claim 1, wherein the receiving (d) comprises receiving checklist data for copying a question to the checklist, comprising:
(d1) receiving a selection to view a questionnaire library, wherein the questionnaire library comprises questions from previous checklists;
(d2) displaying a preview of the questionnaire library; and
(d3) copying a question selected from the questionnaire library to a location in the checklist indicated by a user.

13. The method of claim 12, wherein the copying (d3) comprises copying any assets associated with the selected question.

14. The method of claim 12, further comprising:
(b4) receiving a modification to question parameters of the selected question.

15. The method of claim 14, wherein the question parameters comprises a text for the selected question, at least one possible answer for the selected question, a category for the selected question, a response point value for the at least one possible answer, or a question point value.

16. The method of claim 1, wherein the receiving (d) comprises:
(d1) displaying the checklist with the checklist data in same manner as a user would view the checklist when filling out the checklist.

17. The method of claim 1, further comprising:
(g) receiving by the server the checklist with selected answers for a case;
(h) storing by the server user information and case data; and
(i) storing by the server the selected answers without scoring and associating the selected answer with the user information and the case data.

18. The method of claim 17, further comprising:
(j) receiving by the server a request to generate a report for the stored selected answers for the checklist;
(k) scoring by the server the selected answers and applying any category filters;
(l) determining by the server if question parameters for any question in the checklist is to be modified; and
(m) if so, then returning to the checklist builder interface at the client to modify at least one question parameter.

19. The method of claim 18, further comprising:
(n) rescoring by the server the selected answers and reapplying the category filters; and
(o) generating the report by the server.

20. A method for generating a report for skills assessment of a user, comprising:
(a) receiving by a server a request to generate a report for stored selected answers for at least one checklist, wherein the checklist comprises at least one question for assessing a performance of the user, wherein the selected answers are stored without scoring;
(b) scoring by the server the selected answers and applying any category filters;
(c) determining by the server if question parameters for the at least one question is to be modified;
(d) if so, then returning to a checklist builder interface at a client for modifying the question parameters;
(e) rescoring by the server the selected answers and reapplying the category filters; and
(f) generating the report by the server.

21. The method of claim 20, wherein the returning (d) comprises:
(d1) displaying the checklist builder interface through a browser residing locally to the client;
(d2) receiving modifications to the question parameters for the at least one question through the checklist builder interface at the client, wherein the modifications are stored locally to the client;
(d3) receiving by the client an indication that the at least one checklist is complete; and
(d4) sending the stored checklist data comprising the modified question parameters from the client to the server in a single request.

22. The method of claim 20, wherein the question parameters comprise a text for the at least one question.

23. The method of claim 20, wherein the question parameters comprise a category, wherein the category identifies a type of skill being assessed by the at least one question.

24. The method of claim 20, wherein the question parameters comprise at least one possible answer for the at least one question.

25. The method of claim 20, wherein the question parameters comprise a response point value for a possible answer for the at least one question, wherein the response point value indicates a number of points awarded for choosing the possible answer.

26. The method of claim 20, wherein the question parameters comprise a question point value indicating a number of points awarded for answering the question correctly.

27. A system for skills assessment, comprising:
a server, wherein the server hosts a skills assessment tool, wherein the skills assessment tool comprises a checklist builder; and
a client,
wherein the client requests the checklist builder from the server, receives the checklist builder from the server as a software component, executes the checklist builder software component and displays a checklist builder interface through a browser at the client, receives checklist data for a checklist from a user through the checklist builder interface, wherein the checklist data is stored locally to the client, receives an indication from the user that the checklist is complete, and sends the stored checklist data to the server in a single request.

28. A skills assessment tool for assessing a performance of a user, comprising:
a checklist builder, wherein the checklist builder is downloadable to a client as a software component, wherein when the client executes the checklist builder software component, a checklist builder interface is displayed through a browser at the client, wherein the client receives checklist data through the checklist builder interface, wherein the client sends the checklist data to a server in a single request; and
a reporting tool, wherein the reporting tool receives a request from the client to generate a report comprising stored selected answers for the checklist,
wherein the reporting tool scores the selected answers and applies any category filters,
wherein the reporting tool determines if question parameters for at least one question is to be modified,
wherein if so, then a user is returned to the checklist builder interface at the client for modifying the question parameters,
wherein the reporting tool rescores the selected answers and reapplies the category filters,
wherein the report is generated.

29. The system of claim 28, wherein the question parameters comprise a text for the at least one question.

30. The system of claim 28, wherein the question parameters comprise a category, wherein the category identifies a type of skill being assessed by the at least one question.

31. The system of claim 28, wherein the question parameters comprise at least one possible answer for the at least one question.

32. The system of claim 28, wherein the question parameters comprise a plurality of possible answers for the at least one question, wherein each possible answer comprises a response point value indicating a number of points awarded for choosing the possible answer.

33. The system of claim 28, wherein the question parameters comprise a question point value indicating a number of points awarded for answering the question correctly.

34. A computer readable medium with program instructions for allowing creating of a checklist for skills assessment at a client, wherein the client includes a browser residing locally to the client, wherein the client is in communication with a server, comprising:
(a) sending a request for a checklist builder from the client to the server;
(b) receiving by the client the checklist builder as a software component;
(c) executing the checklist builder software component at the client, and displaying a checklist builder interface through the browser at the client;
(d) receiving checklist data for the checklist through the checklist builder interface at the client, wherein the checklist data is stored locally to the client;
(d) receiving an indication that the checklist is complete through the checklist builder interface at the client; and
(e) sending the stored checklist data from the client to the server in a single request.

35. A computer readable medium with program instructions for generating a report for skills assessment of a user, comprising:
(a) receiving a by a server request to generate a report for stored selected answers for at least one checklist, wherein the checklist comprises at least one question for assessing a performance of the user, wherein the selected answers are stored without scoring;
(b) scoring by the server the selected answers and applying any category filters;
(c) determining by the server if question parameters for the at least one question is to be modified;
(d) if so, then returning to a checklist builder interface at a client for modifying the question parameters;
(e) rescoring by the server the selected answers and reapplying the category filters; and
(f) generating the report by the server.
